(19) United States
(12) Patent Application Publication
(10) Pub. No.: US 2018/0137566 A1
(43) Pub. Date: May 17, 2018

(54) No-Click Institutional Allocation Platform System and Method

(71) Applicant: JPMorgan Chase Bank, N.A., New York, NY (US)

(72) Inventors: Kent A. Paschal, New York, NY (US); Ioannis Vasmatzidis, Verona, NM (US); Munish Kumar, Hackensack, NJ (US); Satyajit Roy Choudhury, Mumbai (IN); Danny Ljungberg, Jersey City, NJ (US)

(73) Assignee: JPMorgan Chase Bank, N.A., New York, NY (US)

(21) Appl. No.: 14/064,565

(22) Filed: Oct. 28, 2013

(51) Int. Cl. G06Q 40/04

(52) U.S. Cl. CPC G06Q 40/04

(57) ABSTRACT

Embodiments of the present invention are directed to a system and method for a no-click institutional allocation platform that automatically matches at least two transactions. The system and method may import at least one customer side allocation and at least one broker-dealer firm-side transaction from an external system using a transaction import engine. The system and method process the imported transactions using the transaction matching engine by matching at least one customer-side allocation to at least one broker-dealer firm side transaction. The system and method may also have the capability to handle any exceptions using an exception handling engine. If the exception is successfully handled or there is no exception, the system and method then automatically settle the matched transaction using a step-out processing engine. The details of the settled transaction are then displayed to a user using a transaction visualization engine.

### TECHNICAL FIELD

Embodiments of the present invention are directed to a system and method for an automated No-Click Institutional Allocation Platform (IAP) that provides authorized users the ability to receive a set of transactions (for example, customer-side allocations) from a central system, and match them with a different set of transactions (for example, firm-side transactions).

### BACKGROUND OF THE INVENTION

Electronic trading, sometimes called e-trading, is a method of electronically trading financial products, including, but not limited to, securities (such as stocks, and bonds), currencies, commodities, derivatives, foreign exchange, and financial derivatives. Information technology is used to bring together buyers and sellers through an electronic trading platform and network to create virtual market places. Examples of virtual marketplaces include NASDAQ™, NYSE™, and Globex™. Electronic trading platforms allow electronic trading to be carried out by users from any location and provide enhanced flexibility over traditional floor trading using open outcry and telephone based trading.

Electronic trading platforms typically stream live market prices on which users can trade and may provide additional trading tools, such as charting packages, news feeds and account management functions. Some platforms have been specifically designed to allow individuals to gain access to financial markets that could traditionally only be accessed by specialist trading firms, such as allowing margin trading on foreign exchange and derivatives, and contract for difference. They may also be designed to automatically trade specific strategies based on technical analysis or to do high-frequency trading.

In the field of electronic trading, step-in and step-out trades are arrangements whereby part or all of a trade is to be settled by a broker other than the broker executing the trade. In step-out trading, each brokerage receives credits or commissions for the share of the trade that it executes. Although different brokerages are executing different blocks of the trade, each block will be executed at the same price. Step-out trading can also refer to an order that is executed entirely by one brokerage that simply gives credits or commissions to other firms for portions of the trade, which it might do if those firms provided research and analysis.

Currently, step-in and step-out trades are performed manually such that a user is required to manually verify transaction details before accepting an allocation from an electronic trade confirmation system, such as Omgeo OASYS™, and match the transaction details with broker-dealer firm-side transactions from institutional trading applications, such as Fidessa™, and others. Further, there is no means by which to set up accounts automatically based on the receipt of an allocation request, and there is no mechanism to process step-out or step-in transactions. Processing is done manually by the purchase and sales group.

Thus, there exists a need for a system and method that will automate the step-in/step-out process without any manual intervention. A system is needed that will allow brokers/dealers to submit their clients' unallocated transactions to the system where they will automatically match with the corresponding Omegeo OASYS™ transactions and allocations, and set up any required accounts through a Straight Through Processing (STP) interface (e.g. Electronic Account Processing—EAP) to the Account Management System (AMS). The allocations may then be booked to the settlement system automatically, without the broker or the investment manager needing to “click” anything.

### BRIEF SUMMARY OF THE INVENTION

In accordance with exemplary embodiments of the present invention, there is provided an institutional allocation platform that operates over a telecommunications network. In one aspect of the invention, a flexible processing system is provided to automate the process of matching, accepting and booking trades during the step-out process. The system implements a computer processor accessing at least one storage medium and comprises interfaces for importing one or more customer-side transactions from an external system, such as an electronic trading system, and match them versus broker-dealer firm-side transactions, received from institutional trading applications. This matching process ensures that the customer-side transactions match the information known to the broker-dealer and provides straight-through-processing to the back office in real-time. The platform may have the ability to automatically match customer-side transactions with broker-dealer firm-side transactions based on one or more attributes. Attributes may be price, quantity, security, commission, or any other financial attributes. The platform may provide a management tool that may allow for automatic account set-up. The platform may also provide automatic step-out processing, including the ability to step-out on a system for reporting and settling trades. A user may access the platform using easy-to-use inquiry screens to review current and past matching and allocation information.

In a further aspect of the invention, a computer-implemented method is provided for automating the process of matching and accepting and booking trades during the step-out process implementing a computer processor accessing at least one storage medium. The method imports one or more customer-side transactions from an external system, such as an electronic trading system, and matches them with broker-dealer firm-side transactions, received from institutional trading applications. This matching process ensures that the customer-side allocations match the information known to the broker-dealer and provides straight-through-processing to the back office in real-time. The method may have the ability to automatically match customer-side allocations with firm-side transactions based on one or more attributes. Attributes may be price, quantity, security, commission, or any other financial attributes. The method may provide an easy-to-use exception monitoring and management tool that may allow for automatic account set-up. The method may also provide automatic step-out processing, including the ability to step-out on a system for reporting and settling trades. The method may also provide a user the ability to review current and past matching and allocation information via easy-to-use inquiry screens.

In another embodiment of the present invention, a flexible processing system is provided to automate the process of matching, accepting and booking trades during the step-out process. The system implements a computer processor accessing at least one storage medium and comprises interfaces for importing one or more customer-side transactions from an external system, such as an electronic trading system, and match them with broker-dealer firm-side transactions, received from institutional trading applications. This matching process ensures that the customer-side transactions match the information known to the broker-dealer and provides straight-through-processing to the back office in real-time. The platform may have the ability to automatically match customer-side transactions with broker-dealer firm-side transactions based on one or more attributes. Attributes may be price, quantity, security, commission, or any other financial attributes. The platform may provide an easy-to-use exception monitoring and management tool that may allow for automatic account set-up. The platform may also provide automatic step-out processing, including the ability to step-out on a system for reporting and settling trades. A user may access the platform using easy-to-use inquiry screens to review current and past matching and allocation information.

### BRIEF DESCRIPTION OF THE DRAWINGS

The present invention is described in detail below with reference to the attached drawings figures, wherein:

FIG. 1A is a block diagram illustrating an operating environment for a No-Click IAP system in accordance with an embodiment of the invention;

FIG. 1B is a block diagram illustrating an operating environment for a No-Click IAP System in accordance with an embodiment of the invention;

FIG. 1C is a flow chart illustrating a method for automating the process of matching, accepting and booking trades during the step-out process in accordance with an embodiment of the invention;

FIG. 1D is a flow chart illustrating a method for automating the process of matching, accepting and booking trades during the step-out process in accordance with an embodiment of the invention;

FIG. 2 is a block diagram illustrating various components of a Transaction(s) Matching Engine in accordance with an embodiment of the invention;

FIG. 3 is an example of a user interface of the customer-side allocations and broker-dealer firm-side transactions grids of a Transaction(s) Matching Engine;

FIG. 4 is an example of a user interface of a View/Add Allocations for Transactions Utility;

FIGS. 5A and 5B are examples of a user interface of a View Details for Transactions Utility;

FIG. 6A is a user interface illustrating an Import Allocations Utility import function in accordance with an embodiment of the invention;

FIG. 6B is a user interface illustrating an Import Allocations Utility paste function in accordance with an embodiment of the invention;

FIG. 6C is an example of a file format that may be used by an Import Allocations Utility import function;

FIG. 6D is an example of a file that may be used by an Import Allocations Utility import and/or paste function;

FIG. 7 is a user interface illustrating a View Audit Trail Utility in accordance with an embodiment of the invention;

FIG. 8 is a block diagram illustrating various components of a Manual Matching and Allocation Utility;

FIG. 9A is a user interface illustrating a Modify, Accept and Book Transaction(s) Utility;

FIG. 9B is a user interface illustrating a Create Transaction Utility;

FIG. 10 is a user interface illustrating a Match and Accept Transaction(s) Utility;

FIG. 11 is an example of a user interface of a Merge Transaction(s) Utility;

FIG. 12 is a block diagram illustrating various components of an Exception(s) Handling Engine;

FIG. 13 is a user interface illustrating a View Exception(s) Utility in accordance with an embodiment of the invention;

FIG. 14 is a user interface illustrating a View Details Utility in accordance with an embodiment of the invention;

FIG. 15 is a user interface illustrating a View/Edit Allocations Utility in accordance with an embodiment of the invention;

FIG. 16 is a block diagram illustrating various components of a Transaction(s) Visualization Engine;

FIG. 17 is a user interface illustrating a View Transaction(s) Utility 1610 and the Filter Utility;

FIG. 18 is a user interface illustrating a View Allocations Utility;

FIG. 19 is a user interface illustrating a View Match Summary and Allocations Utility;

FIG. 20 is a block diagram illustrating various components of an Administration Engine in accordance with an embodiment of the invention;

FIG. 21 is a user interface illustrating a Step-out Broker List Utility;

FIG. 22A is a user interface illustrating the add customer function of a Customer Setup Utility;

FIG. 22B is a user interface illustrating an edit customer function of a Customer Setup Utility;

FIG. 22C is a user interface showing a remove customer function of a Customer Setup Utility;

FIG. 22D is a user interface showing an import customers function of a Customer Setup Utility;

FIG. 23 is a user interface showing a General Settings Utility.

### DETAILED DESCRIPTION OF PREFERRED EMBODIMENTS

Embodiments of the present invention are directed to a No-Click Allocation method and system for allocating and processing transactions. The method and system provide entitled users the ability to receive a set of transactions (for example, customer-side allocations) from a system (for example, an electronic trade confirmation system such as Omgeo OASYS™) and match them with a different set of transactions (for example, broker-dealer firm-side transaction average price transactions) from another system (for example, institutional trading applications such as Fidessa™ and others). Although the present specification discusses this automatic matching process in terms of customer-side allocations and broker-dealer firm-side transactions, it is readily understood that the disclosed system and method may be used to match other types of transactions, such as bond transactions, equities transactions, genes, census records, hereditary records, medical records, foreign trades, etc.

Embodiments of the method and system ensure that the customer-side allocations match the information known to the broker-dealer and provide straight-through-processing to the back office in real-time.

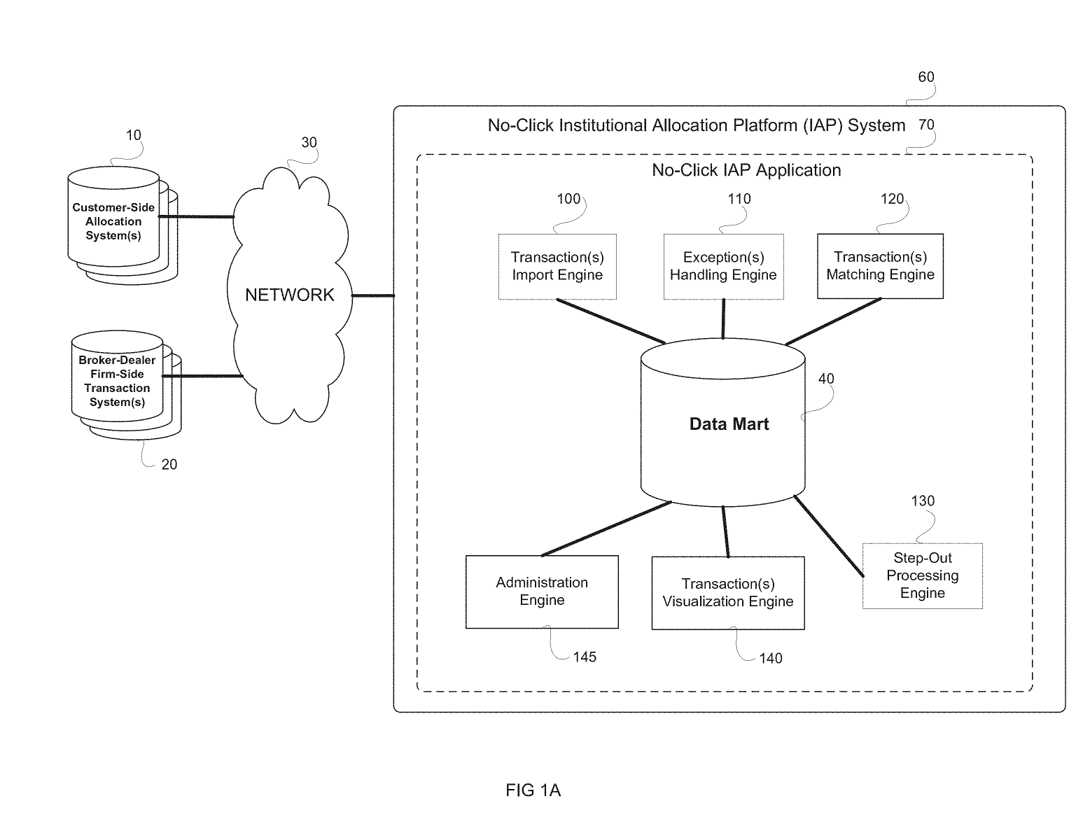

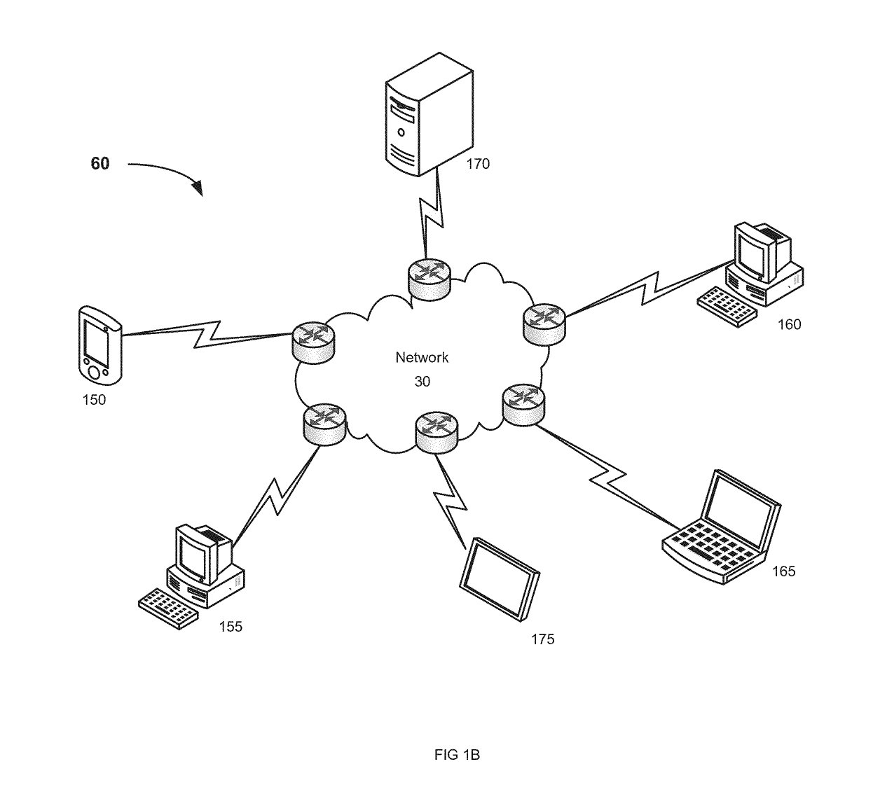

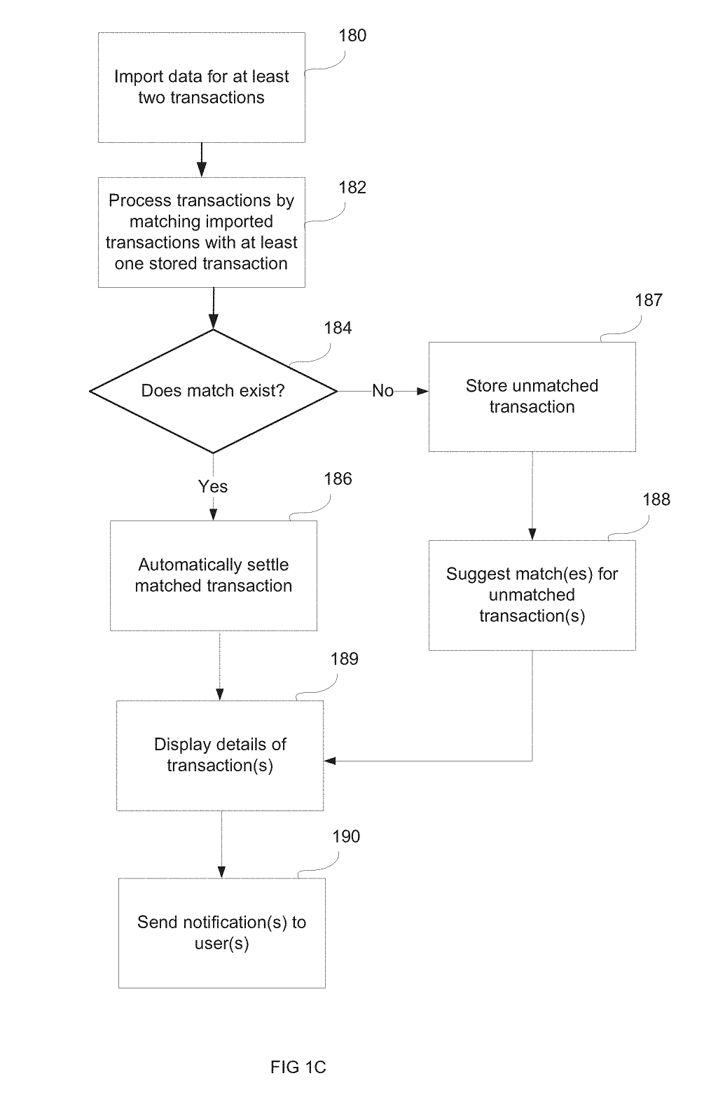

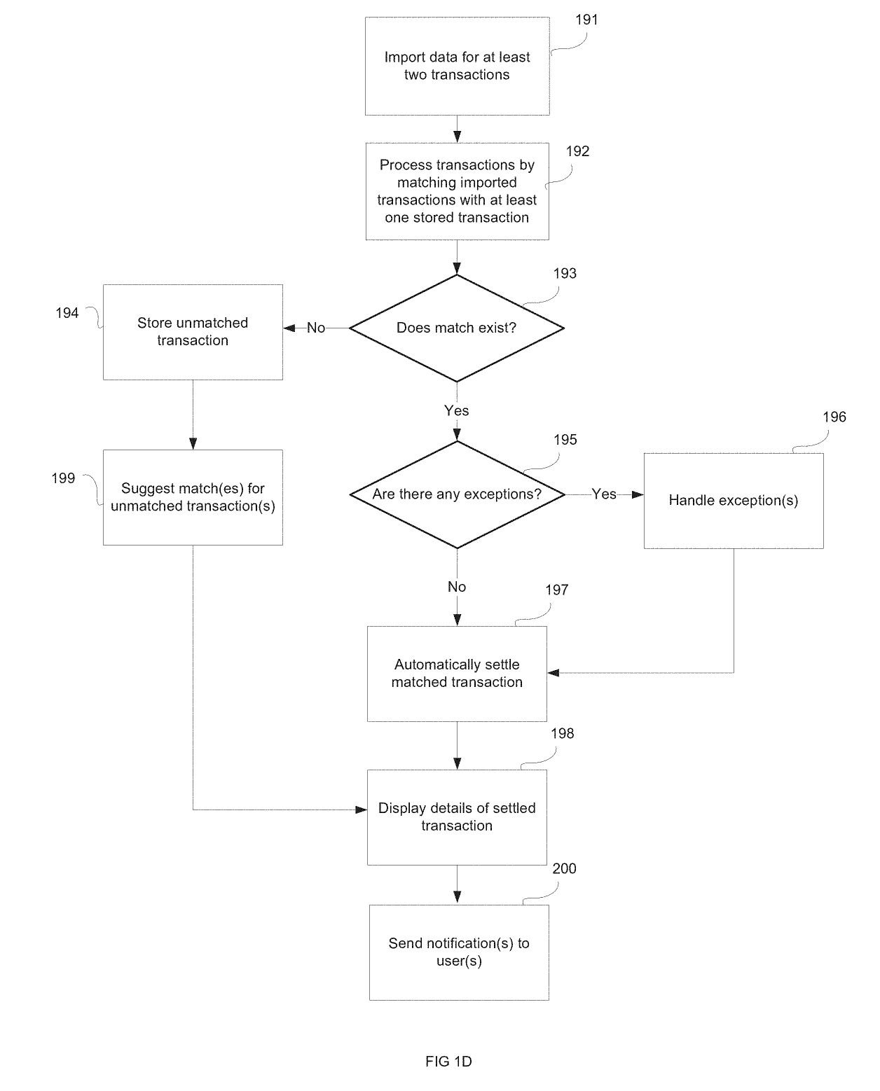

FIG. 1A is a block diagram illustrating an operating environment for a No-Click IAP system in accordance with an embodiment of the invention. The No-Click IAP System 60 includes a No-Click IAP Application 70. The No-Click IAP System 60 is connected through a communications medium over a Network 30, such as the internet, an intranet, a local-area-network (LAN), a wide-area-network (WAN), etc, to one or more Customer-Side Allocation System(s) 10 and one or more Broker-Dealer Firm-Side Transaction System(s) 20.

The Customer-Side Allocation System(s) 10 may provide customer-side allocations and the Broker-Dealer Firm-Side Transaction System(s) 20 may provide broker-dealer side transactions.

The No-Click IAP Application 70 includes a Data Mart 40, a Transaction(s) Import Engine 100, an Exception Handling Engine 110, a Transaction(s) Matching System 120, a Step-Out Processing Engine 130, a Transaction(s) Visualization Engine 140, and an Administrative Engine 145. The No-Click IAP Application 70 may bring data from the Customer-Side Allocation System(s) 10 and the Broker-Dealer Firm-Side Transaction System(s) 20 using the Transaction(s) Import Engine 100 in the form of data feeds. The data may then be uploaded in the Data Mart 40. The Data Mart 40 may not be the system of record for the data brought from the Customer-Side Allocation System(s) 10 and the Broker-Dealer Firm-Side Transaction System(s) 20. In an embodiment of the invention, the Data Mart 40 may be a database that is local to the No-Click IAP System 60 and that stores data to be used by the No-Click IAP Application 70 to perform the allocation and matching of transactions.

Once the data feeds are configured or data is uploaded, the Transaction(s) Matching Engine 120 may automatically match the customer-side allocations and the broker-dealer firm-side transactions (transactions). The matching may be based on one or more matching criteria. Examples of the matching criteria include, but are not limited to, price, investment manager, quantity, side, trade date, settlement date, commission, and instrument. Tolerances may be defined for one or more of the matching criteria. If one or more transactions cannot be automatically matched, the Transaction(s) Matching Engine 120 may provide a utility for a user to view the unmatched transactions and manually match them. The Transaction(s) Matching Engine 120 may also provide a utility to suggest matches for unmatched transactions. The Transaction(s) Matching Engine 120 may also allow a user to view all matched and unmatched transactions and allow the user to manually match and allocate transactions.

In an embodiment of the invention, the Exception(s) Handling Engine 110 may perform error checking and handle any exceptions occurring in the No-Click IAP Application 70. Examples of exceptions include, but are not limited to, a failed match, network error, data import error, step-out processing error, or any other error during the execution of the No-Click IAP Application 70.

Once a transaction has been matched by the Transaction(s) Matching Engine 120, the Step-Out Processing Engine 130 may complete the transaction and send a notification to one or more users. A user may then be able to view the matched transaction(s) using the Transaction(s) Visualization Engine 140. The user may also be able to view unmatched and/or pending transactions using the Transaction(s) Visualization Engine 140. The user may be able to update various settings and attributes of the No-Click IAP System 60 using the Administration Engine 145.

FIG. 1B is a block diagram illustrating an operating environment for a No-Click IAP System 60 in accordance with an embodiment of the invention. Those skilled in the art will appreciate that the invention may be practiced with various computer system configurations, including hand-held wireless devices such as mobile phones, smart phones or Personal Digital Assistants (PDAs) 150, multiprocessor systems 155, microprocessor-based or programmable consumer electronics 160, minicomputers 165, mainframe computers 170, Tablets (iPad™, Samsung Galaxy™, etc.) 175, and the like. The invention may also be practiced in distributed computing environments where tasks are performed by remote processing devices that are linked through a communications network. In a distributed computing environment, program modules may be located in both local and remote computer storage media including memory storage devices.

Generally, it should be noted that the components depicted and described herein above may be, or include, a computer or multiple computers. Although the components are shown as discrete units, all components may be interconnected or combined. The components may be described in the general context of computer-executable instructions, such as program modules, being executed by a computer. Generally, program modules include routines, programs, objects, components, data structures, etc., that perform particular tasks or implement particular abstract data types.

FIG. 1C is a flow chart illustrating a method for automating the process of matching, accepting and booking trades during the step-out process in accordance with an embodiment of the invention. The method may import data in 180 for at least two transactions from an external system. The data may include customer-side allocations and broker-dealer side transactions. Once the data is uploaded, the transactions may be automatically processed in 182 by matching them with one or more transactions that may have been previously imported by the method. In an embodiment of the invention, the imported transactions may be matched with each other.

The matching may be based on one or more matching criteria. Examples of the matching criteria include, but are not limited to, price, investment manager, quantity, side, trade date, settlement date, commission, and instrument. Tolerances may be defined for one or more of the matching criteria. If a match exists in 184, the matched transaction(s) may be automatically settled in 186. The method may then display details of the matched transaction in 189.

If one or more transactions cannot be automatically matched, they may be stored for future potential matches in 187. The method may display the unmatched transactions and allow a user to manually match them in 189. In an embodiment of the invention, the method may suggest matches for unmatched transactions in 188. A notification may be sent to one or more users in 190 informing the user(s) of any matched and/or unmatched transactions.

FIG. 1D is a flow chart illustrating a method for automating the process of matching, accepting and booking trades during the step-out process in accordance with an embodiment of the invention. The method may import data in 191 for at least two transactions from an external system. The data may include customer-side allocations and broker-dealer side transactions. Once the data is uploaded, the transactions may be automatically processed in 192 by matching them with one or more transactions that may have been previously imported by the method. In an embodiment of the invention, the imported transactions may be matched with each other.

The matching may be based on one or more matching criteria. Examples of the matching criteria include, but are not limited to, price, investment manager, quantity, side, trade date, settlement date, commission, and instrument. Tolerances may be defined for one or more of the matching criteria. If a match exists in 193, the method may perform exception checking in 195. Examples of exceptions include, but are not limited to, a failed match, network error, data import error, step-out processing error, or any other error during the execution of the method. If an exception exists, the method may handle it in 196. If no exception exists, or once the exception has been successfully handled in 196, the method may then automatically settle the matched transaction(s) in 197. The method may then display details of the matched transaction in 198.

If one or more transactions cannot be automatically matched, they may be stored for future potential matches in 194. The method may display the unmatched transactions and allow a user to manually match them in 198. In an embodiment of the invention, the method may suggest matches for unmatched transactions in 199. A notification may be sent to one or more users in 200 informing the user(s) of any matched and/or unmatched transactions.

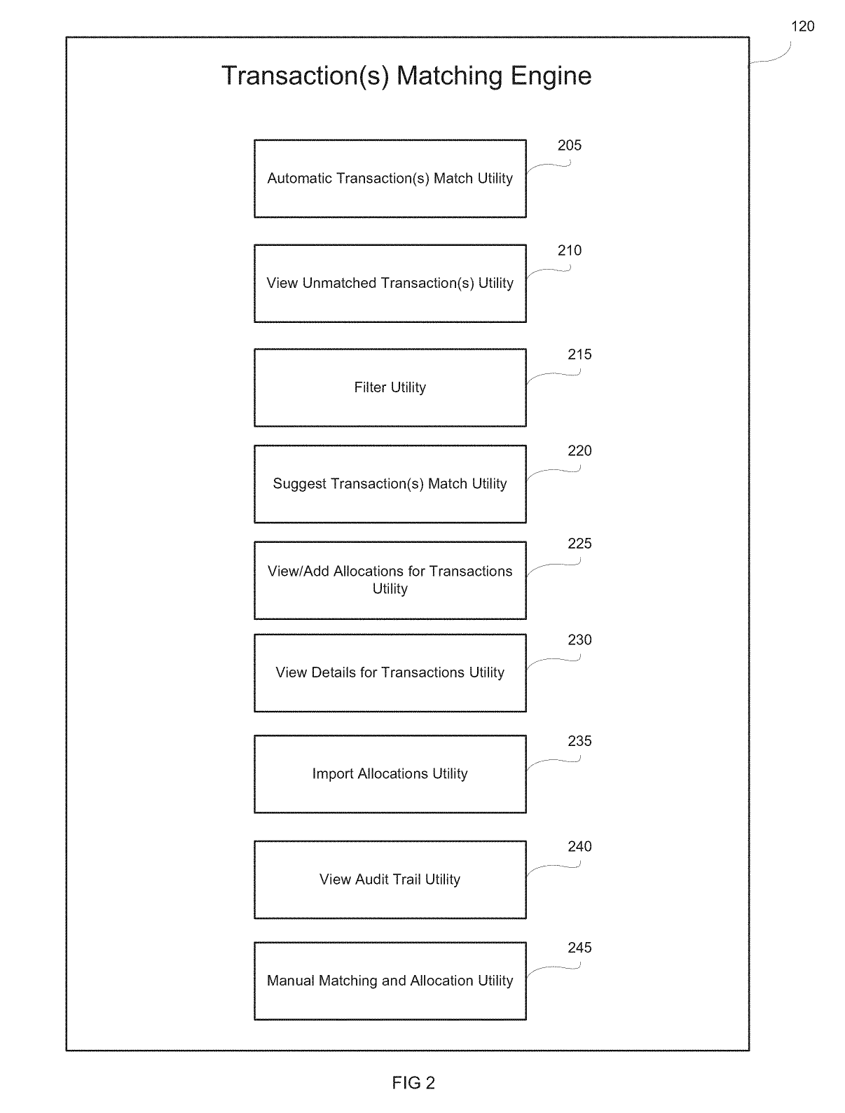

FIG. 2 is an exemplary embodiment illustrating various components of the Transaction(s) Matching Engine 120. The Transaction(s) Matching Engine 120 may include any combination of the following modules and in some embodiments may include a greater or lesser number of modules. The Transaction(s) Matching Engine 120 may include an Automatic Transaction(s) Match Utility 205 that may automatically match customer-side allocations and broker-dealer firm-side transactions based on one or more criteria. The criteria for matching may depend upon the characteristics of the transactions to be matched. For example, the Automatic Transaction(s) Match Utility 205 may use the following criteria to match trade transactions: price, investment manager, quantity, side, trade date, settlement date, commission, and instrument. Furthermore, the Automatic Transaction(s) Match Utility 205 may use pre-set tolerance levels for the matching criteria such that if the value or the customer-side allocation and the broker-dealer firm side transaction differ by a value that is within the pre-set tolerance limits, then the two transactions may be automatically matched.

The Transaction(s) Matching Engine 120 may also include a View Unmatched Transaction(s) Utility 210 that allows a user to view customer-side allocations and broker-dealer firm-side transactions that the Automatic Transaction(s) Match Utility 205 was unable to match. The unmatched customer-side allocations and broker-dealer firm-side transactions may be displayed in separate grids.

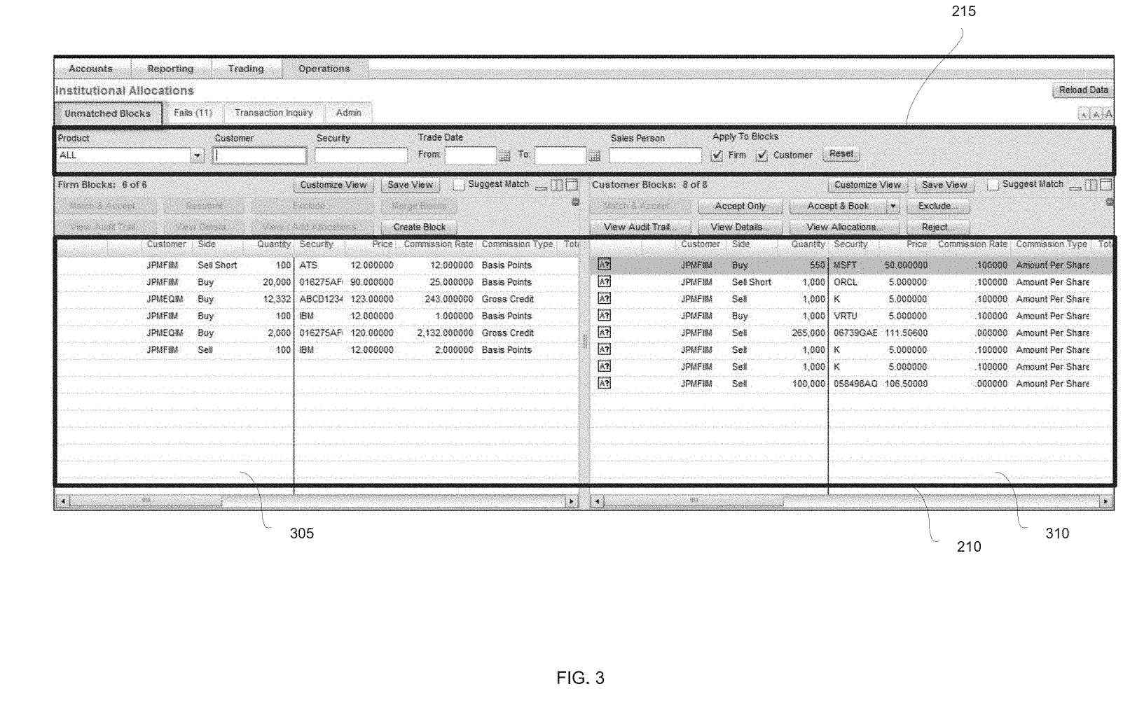

An example of a user interface of the customer-side allocations and broker-dealer firm-side transactions grids is shown in FIG. 3. The grids may display detailed information about the unmatched transactions. For example, the customer-side allocations grid 310 may display the customer name, side of the transaction (for example, Buy, Sell, Sell Short, etc.), quantity, security name, price, commission rate, commission type, etc. Similarly, the broker-dealer firm-side transaction grid 305 may display the customer name, side of the transaction (for example, Buy, Sell, Sell Short, etc.), quantity, security name, price, commission rate, commission type, etc.

The Transaction(s) Matching Engine 120 may also include a Filter Utility 215 that allows a user to filter the transactions. In one embodiment of the invention, different filter criteria are provided for the customer-side allocations and broker-dealer firm-side transactions. Examples of filter criteria include, but are not limited to product, customer id, customer name, security, trade date, sales person, side, etc. The available values of a filter criterion may be dynamically populated based on one or more of the other filter criteria values. A user may also be able to type in a value in a filter criteria field. A type-ahead functionality may be available that may populate potential matches. An example of a user interface of the filter criteria is shown in FIG. 3.

The Transaction(s) Matching Engine 120 may also include a Suggest Transaction(s) Match Utility 220 that may identify customer-side allocations that are candidate matched for broker-dealer firm-side transactions, and vice-versa. The Suggest Transaction(s) Match Utility 220 may identify potential matches based on one or more matching criteria. The matching criteria used by the Suggest Transaction(s) Match Utility 220 may be the same or different from that used by the Automatic Transaction(s) Match Utility 205 to automatically match unmatched transactions.

The Transaction(s) Matching Engine 120 may also include a View/Add Allocations for Transactions Utility 225 that allows users to allocate a transaction to one or more allocation accounts. A user may be able to allocate a transaction amount partially or fully to an allocation account. In an embodiment of the invention, the user may be able to adjust the various attributes of the transaction including, but not limited to, price, commission rate, commission type, broker of credit, soft dollar, and trailer code. A user may also be able to add comments for the allocation. A user may also be able to edit and/or delete allocations that they have previously added but not submitted.

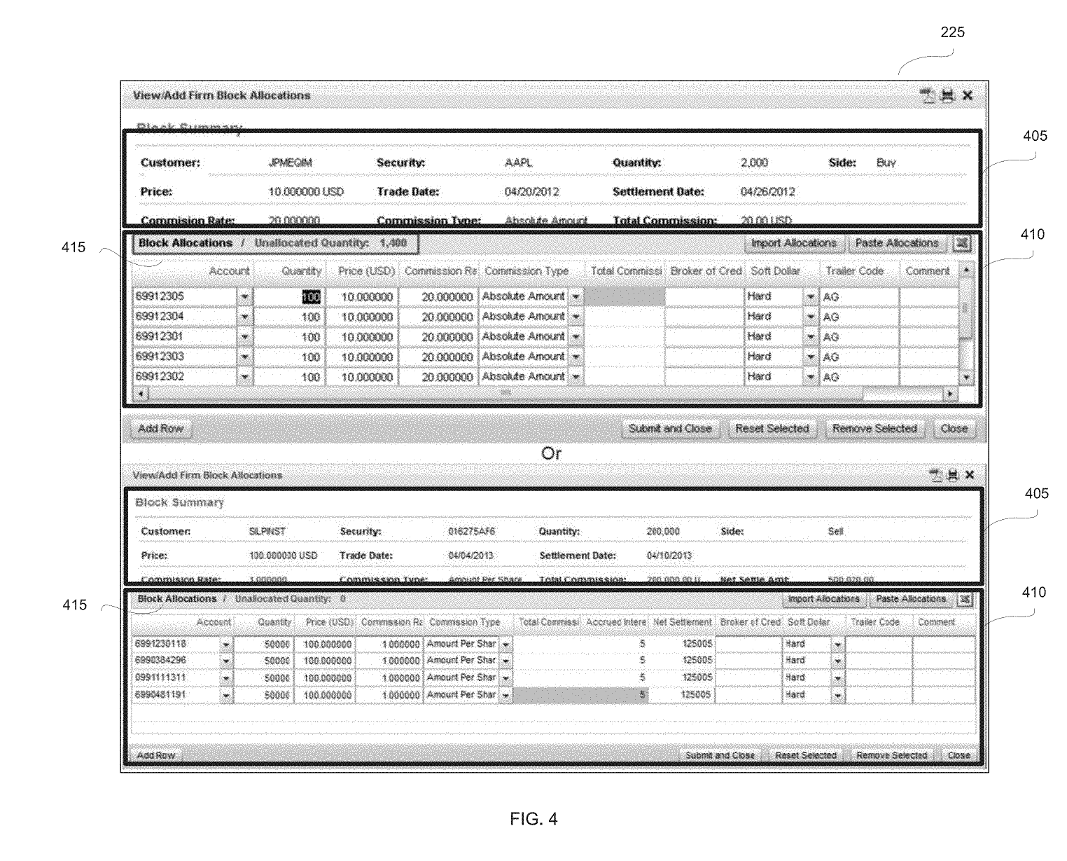

An example of a user interface of the View/Add Allocations for Transactions Utility 225 is shown in FIG. 4. The user interface may have a section 405 that displays details about a transaction, including but not limited to, customer, security, quantity, side, price, trade date, settlement date, commission rate, commission type and total commission. The user interface may have another section 410 that displays one or more allocation accounts associated with a transaction, including details about the allocations, such as, the allocation account number, quantity allocated, price, commission rate, commission type, total commission, broker name, trailer code, accrued interest and comments. The user interface may also display in 415 the total allocated/unallocated quantity for a transaction.

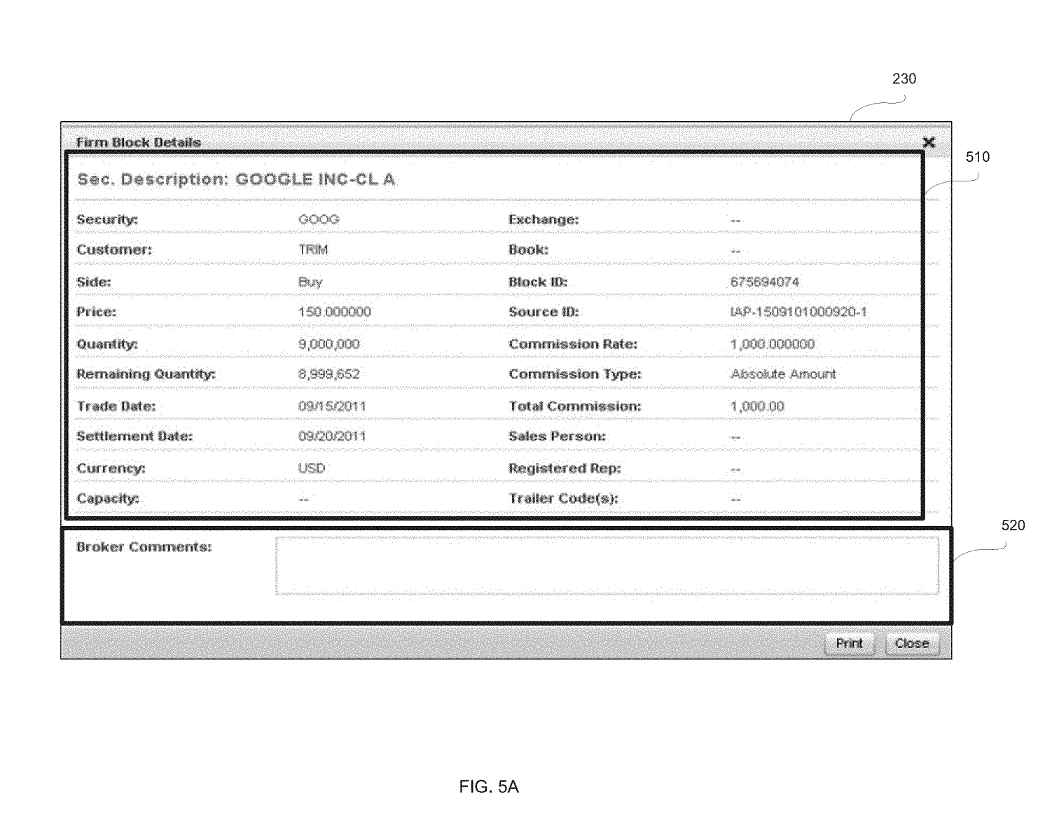

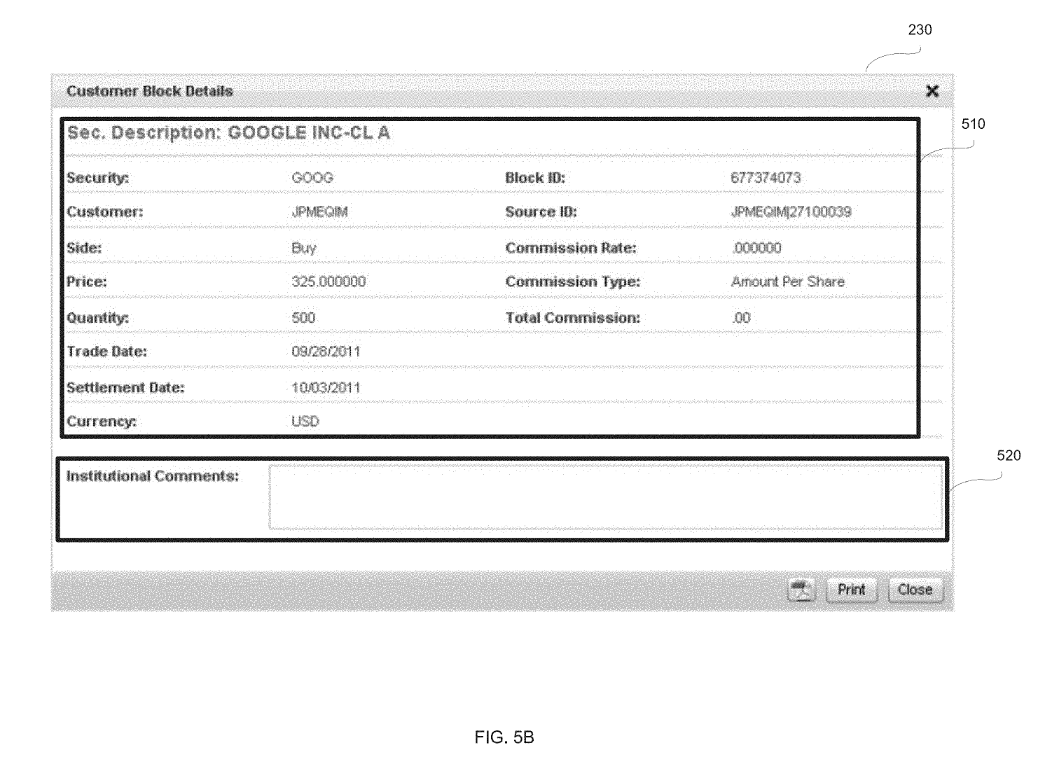

The Transaction(s) Matching Engine 120 may also include a View Details for Transactions Utility 230 that allows a user to view detailed information for one or more transactions, including, but not limited to, transaction id, security, customer, side, quantity, remaining quantity, exchange, book, sales person, registered representatives, trailer codes, coupon rate, accrued interest, net settlement amount, currency, price, trade date, settlement date, capacity, source id, commission rate, commission type, total commission, and comments. Examples of a user interface of the View Details for Transactions Utility 230 is shown in FIGS. 5A and 5B. Section 510 may display detailed information for a transaction. A user may also be able to add comments to the transaction using a textbox 520.

The Transaction(s) Matching Engine 120 may also include an Import Allocations Utility 235 that allows users to import allocations from an external source. For example, the Import Allocations Utility 235 may allow a user to import allocations from a spreadsheet, a comma separated file, an XML file, etc. Importing allocations using the Import Allocations Utility 235 may overwrite the existing allocations stored in the No-Click IAP System 60. A user may be able to import all the contents of the file being imported. A user may also be able to select the portions of the file that are being imported. The Import Allocations Utility 235 may also allow the user to undo the import and revert the allocations to their original state (before import).

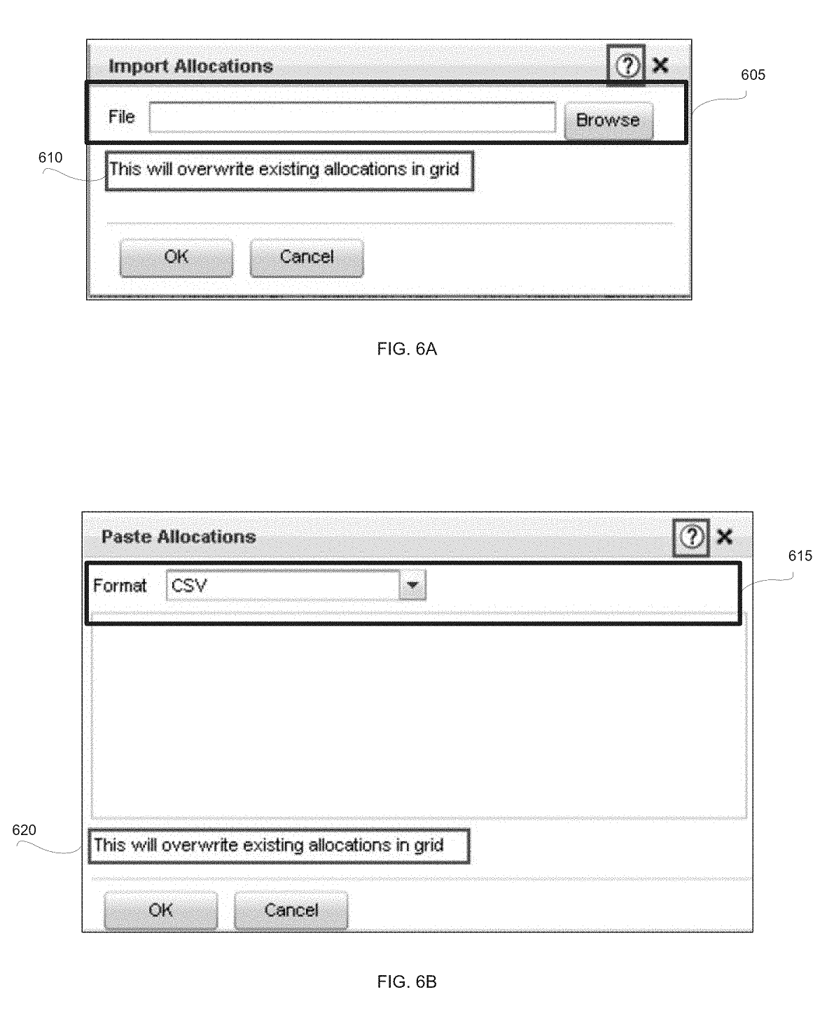

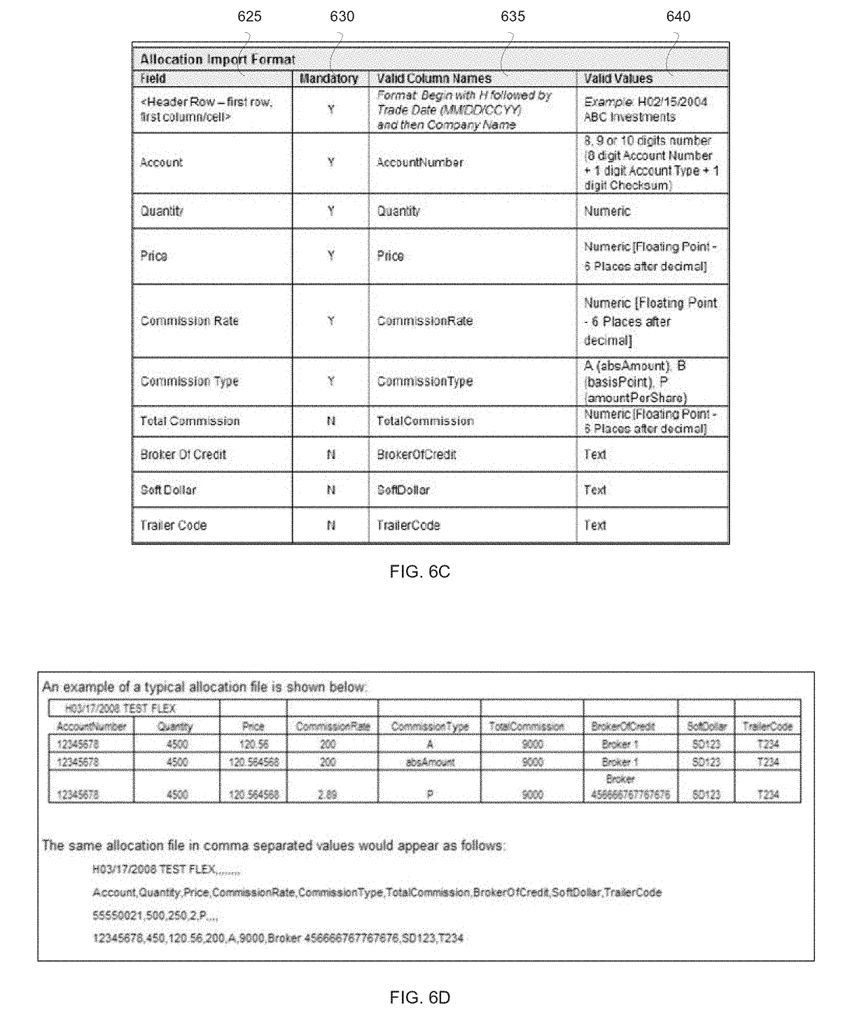

An example of a user interface of the Import Allocations Utility 235 import function is shown in FIG. 6A. A user may be able to select a file to be imported using a browsing option or 605. The user interface may display a warning message 610 informing the user that the import may overwrite existing allocations.

The Import Allocations Utility 235 may also allow a user to copy and paste allocations from an external source. For example, the Import Allocations Utility 235 may allow a user to copy and paste allocations from a spreadsheet, a comma separated file, an XML file, etc. Copying and pasting allocations using the Import Allocations Utility 235 may overwrite the existing allocations stored in the No-Click IAP System 60. A user may be able to copy and paste all the contents of the file being imported. A user may also be able to select the portions of the file that are being copied and pasted. The Import Allocations Utility 235 may also allow the user to undo the paste and revert the allocations to their original state (before copy-paste).

An example of a user interface of the Import Allocations Utility 235 paste function is shown in FIG. 6B. The user may be able to select the format of the file to be copied and pasted in 615. The user interface may display a warning message 620 informing the user that the copy/paste may overwrite existing allocations.

An example of a file format that may be used by the Import Allocations Utility 235 import function is shown in FIG. 6C. The file format may specify the fields contained in the file 625 and whether the field is mandatory 630. The file format may also specify valid column names for the data rows in the file 635 and examples of valid values for each column 640. An example of a file that may be used by the Import Allocations Utility 235 import and/or paste function is shown in FIG. 6D. The file may have one or more rows of allocations to be imported into the No-Click IAP System 60.

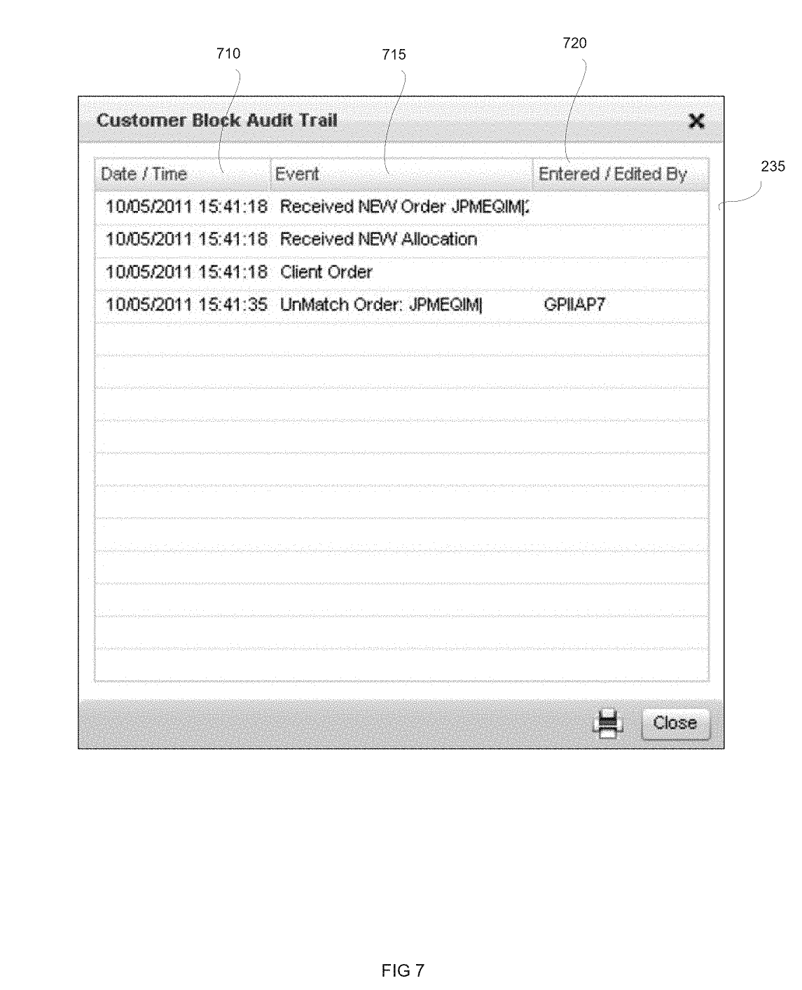

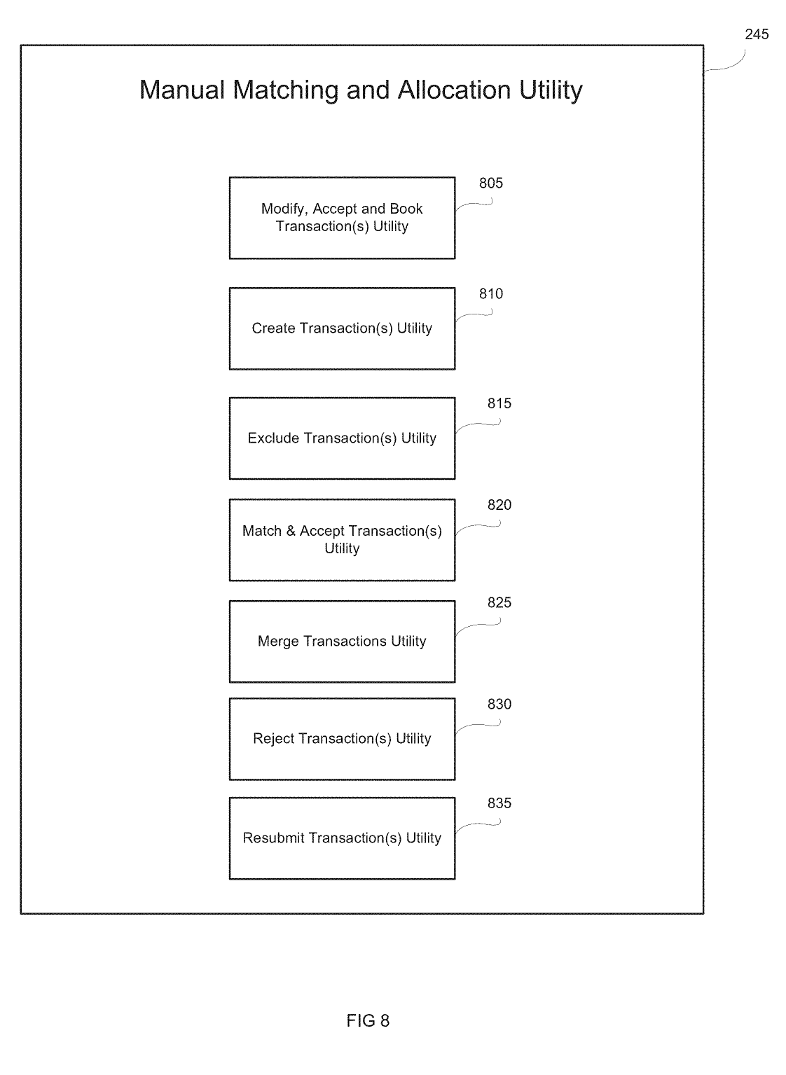

The Transaction(s) Matching Engine 120 may also include a View Audit Trail Utility 240 that allows users to view any events associated with a transaction. For example, View Audit Trail Utility 235 may display the details of an update that a user performed for a transaction. An example of a user interface of the View Audit Trail Utility 235 is shown in FIG. 7. The user interface may display the Date/Time of an event 710, an event description 715 and an identification number of the user/system that performed the event 720.

The Transaction(s) Matching Engine 120 may also include a Manual Matching and Allocation Utility 245 that allows a user to manually match unmatched transactions. In an embodiment of the invention, if the Automatic Transaction(s) Match Utility 205 is not able to automatically match one or more customer-side allocations and the broker-dealer firm-side transactions, the Transaction(s) Matching Engine 120 may allow the user to manually match the unmatched transactions using the Manual Matching and Allocation Utility 245.

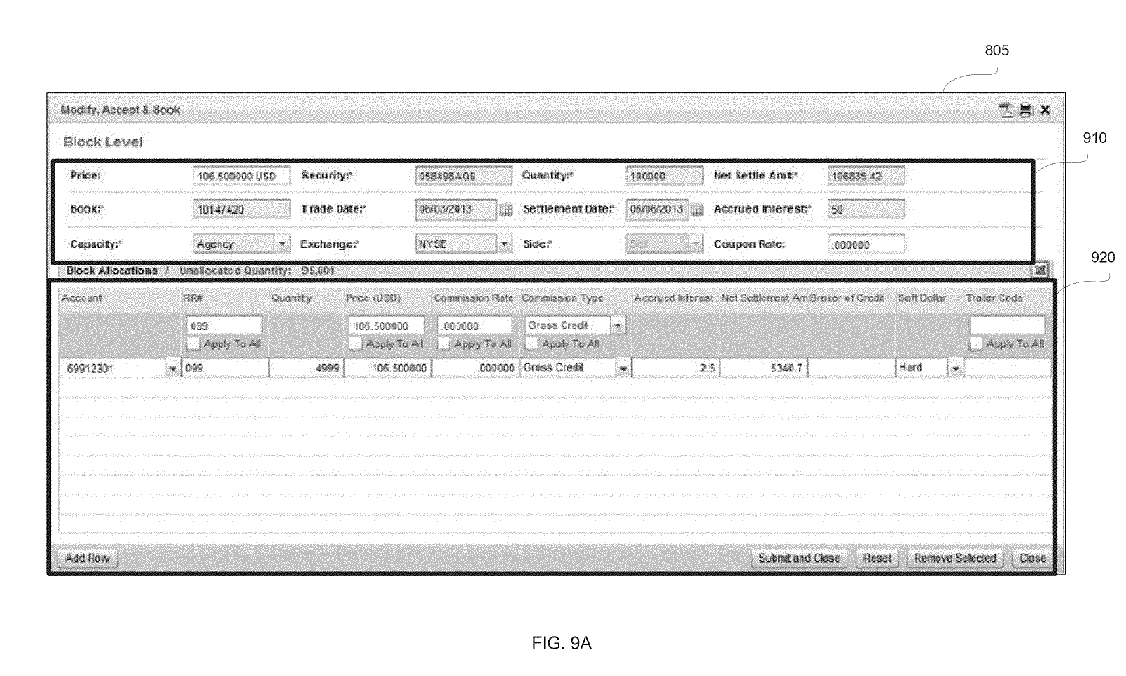

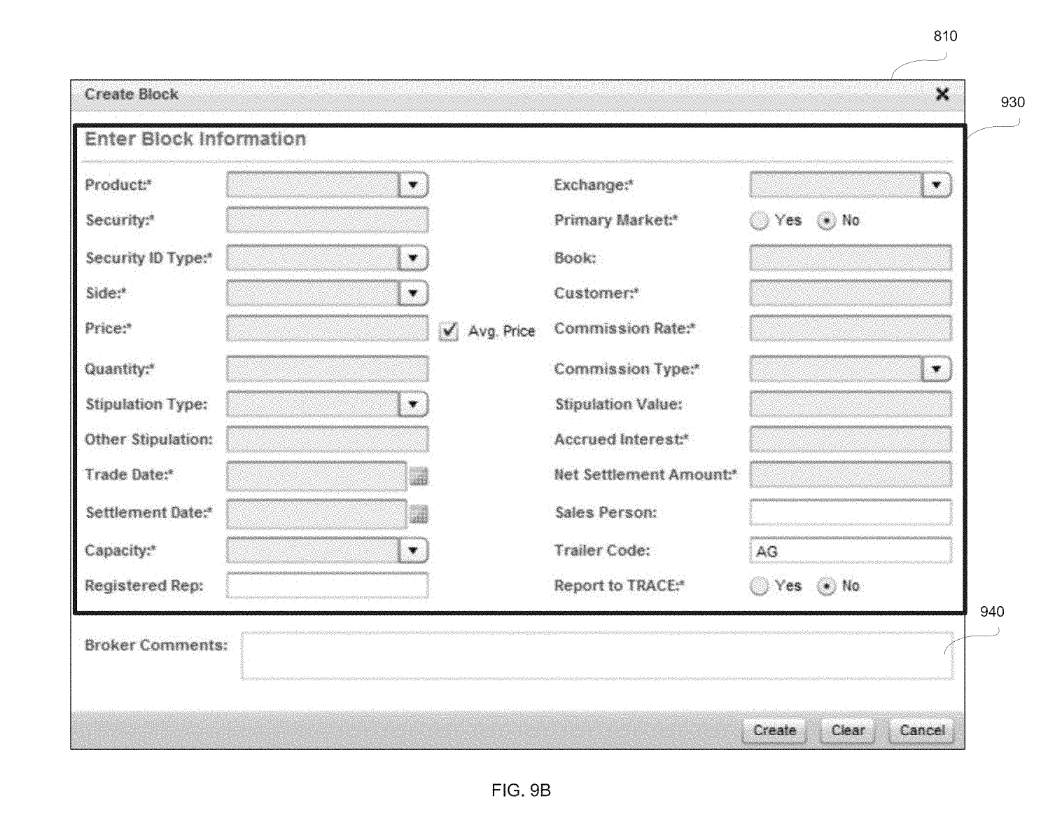

FIG. 8 shows various components of the Manual Matching and Allocation Utility 245. The Manual Matching and Allocation Utility 245 may include any combination of the following modules and in some embodiments may include a greater or lesser number of modules. The Manual Matching and Allocation Utility 245 may include a Modify, Accept and Book Transaction(s) Utility 805. An example of a user interface of the Modify, Accept and Book Transaction(s) Utility 805 is shown in FIG. 9A. A user may be able to select an unmatched transaction and manually accept it. A user may also be able to select a transaction, modify one or more parameters associated with the transaction 910, and accept the changes. Examples of parameters associated with a transaction include, but are not limited to, price, security, quantity, net settlement amount, book, trade date, settlement date, accrued interest, capacity, exchange, side, and coupon rate. Once the user has accepted a transaction, he/she may then be able to book the transaction. A user may further be able to update one or more allocation accounts associated with the transaction using a transaction allocation section 920. A user may also be able to modify existing allocations associated with a transaction using the transaction allocation section 920.

The Manual Matching and Allocation Utility 245 may include a Create Transaction Utility 810 that allows a user to manually create a transaction. An example of a user interface of the Create Transaction Utility 810 is shown in FIG. 9B. The user may have to enter one or all of the criteria, 930, required to create the transaction. In an embodiment of the invention, one or more criteria required to create a transaction may be auto-populated based on other criteria entered by the user. Examples of criteria required to create a transaction include, but are not limited to product, security, exchange, security id, security type, primary market, side, book, price, customer, quantity, commission rate, stipulation type, stipulation value, trade date, commission type, sales person, settlement date, registered representative, capacity, trailer code(s), and report. The user may also add comments 940 to a transaction.

The Manual Matching and Allocation Utility 245 may also include an Exclude Transaction(s) Utility 815 that allows a user to exclude one or more transactions from matching. A user may be able to select multiple transactions to exclude at a time. The selected transactions may then be excluded from the automatic matching performed by the Automatic Transaction(s) Match Utility 205. A user may be able to specify a reason for excluding the one or more transactions.

The Manual Matching and Allocation Utility 245 may also include a Match and Accept Transaction(s) Utility 820 that allows a user to manually match selected transactions. The user may be able to use the Suggest Transaction(s) Match Utility 220 to identify one or more potential matches for an unmatched transaction. The user may then match an unmatched transaction to a transaction suggested by the Suggest Transaction(s) Match Utility 820, or he/she may decide to match the unmatched transaction to a different transaction.

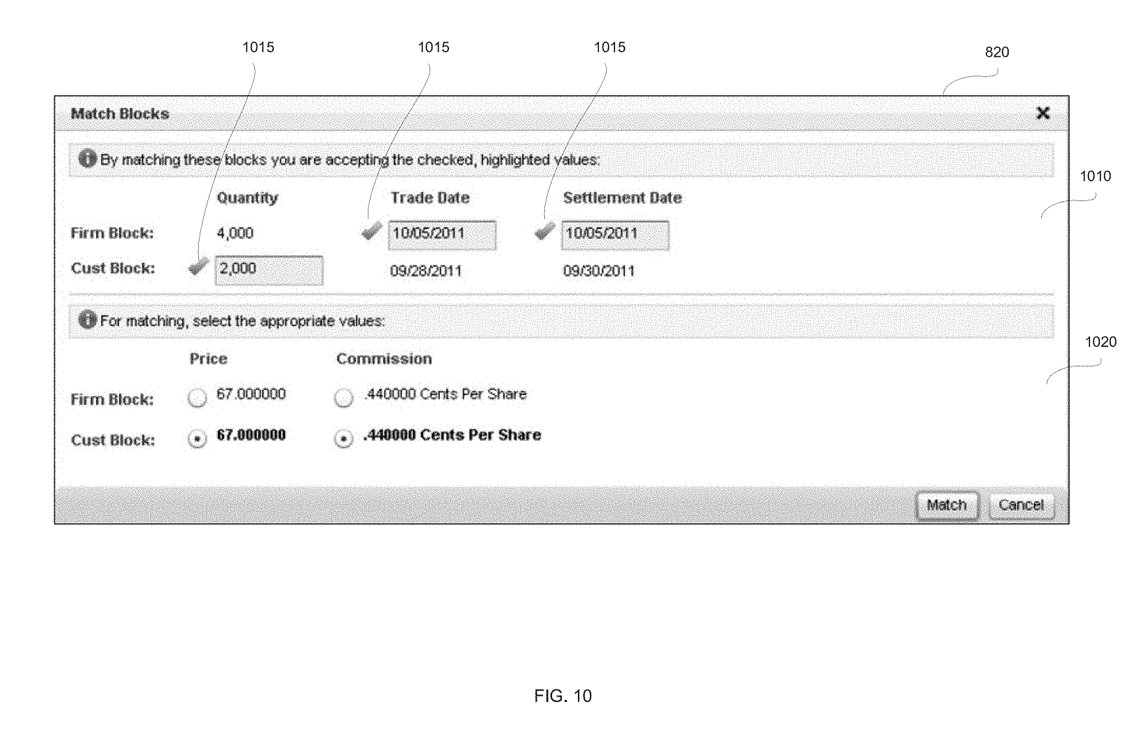

An example of a user interface of the Match and Accept Transaction(s) Utility 820 is shown in FIG. 10. The user interface may display relevant parameters 1010 associated with both the transactions being matched. The display may also indicate the details that match using a visual or audible indicator 1015. The user may further be able to edit and/or select values one or more parameters for the matched transactions 1020.

A transaction may be associated with a customer name. The No-Click IAP Application 70 may store a list of customer names in the Data Mart 40 (mapped customers). However, a transaction may be associated with a customer name that is not mapped to the list of customer names maintained by the No-Click IAP Application 70. The Match and Accept Transaction(s) Utility 820 may map any unmapped customer names under the customer that the user has indicated to be mapped. The Match and Accept Transaction(s) Utility 820 may also keep a track of the source system which supplied the transaction with the unmapped customer name.

A user may also have the ability to merge one or more mapped customers to form one merged customer. The Match and Accept Transaction(s) Utility 820 may merge two or more customers under one existing customer. The Match and Accept Transaction(s) Utility 820 may merge two or more customers into a new customer created by the user. The Match and Accept Transaction(s) Utility 820 may merge two or more customers into a third customer that is already mapped in the No-Click IAP Application 70. When merging one or more mapped customers, the Match and Accept Transaction(s) Utility 820 may not transfer duplicate account information when merging customers.

The Manual Matching and Allocation Utility 245 may also include a Merge Transaction(s) Utility 825 that allows users to select two or more transactions and replace them with a manually created transaction. The Merge Transaction(s) Utility 825 may be available only if a pre-set number of criteria used to automatically match transactions match between the two or more transactions to be merged. For example, Merge Transaction(s) Utility 825 may be available only if the following criteria match among the two or more transactions selected to be merged: customer, side, symbol, trade date and, settlement date. If the pre-set numbers of criteria match, the user may then be able to modify other parameters to create a merged transaction.

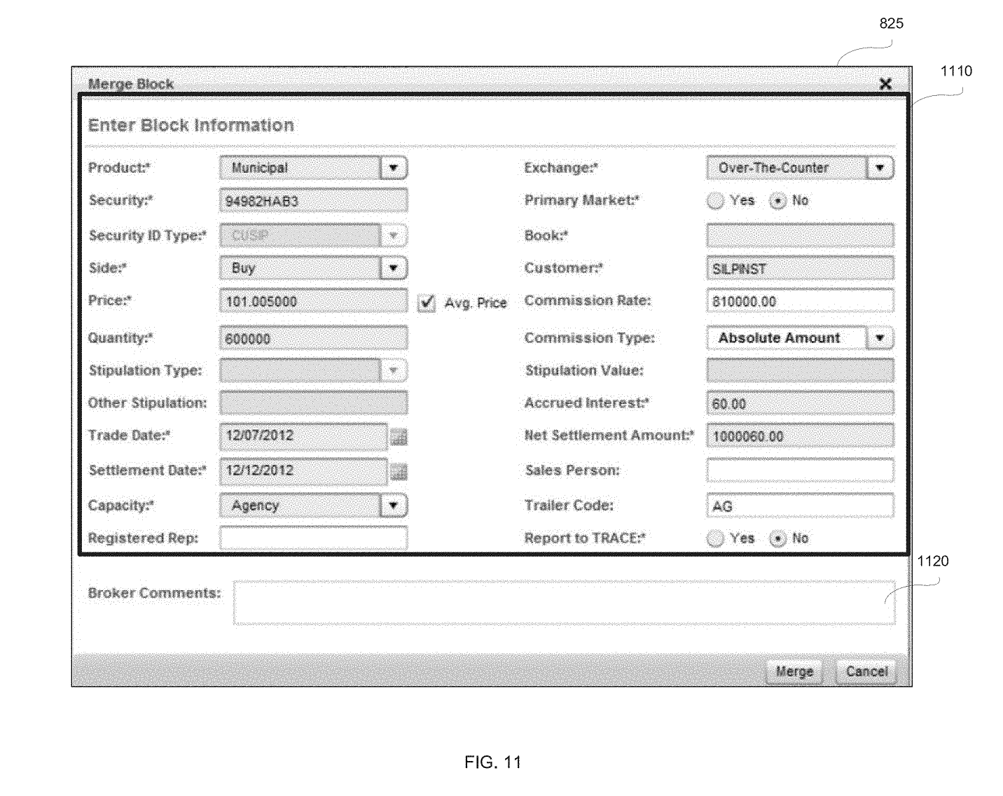

An example of a user interface of the Merge Transaction(s) Utility 825 is shown in FIG. 11. A user may be able to edit one or more parameters 1110 associated with the merged transaction. Examples of the parameters include, but are not limited to, product, security id type, side, price, quantity, stipulation type, other stipulation, trade date, settlement date, capacity, registered representative, exchange, primary market (Yes/No), book, customer, commission rate, commission type, stipulation value, accrued interest, net settlement amount, sales person, and trailer code. The user may also add comments 1120 to a transaction.

The Manual Matching and Allocation Utility 245 may also include a Reject Transaction(s) Utility 830 that allows users to reject one or more selected transactions. A user may be able to reject multiple transactions at a time. The Manual Matching and Allocation Utility 245 may also include a Resubmit Transaction(s) Utility 835 that allows users to resubmit one or more selected transactions for booking. A user may be able to resubmit multiple transactions at a time. If resubmission is successful, the resubmitted transactions may be booked and removed from the list of unmatched transactions.

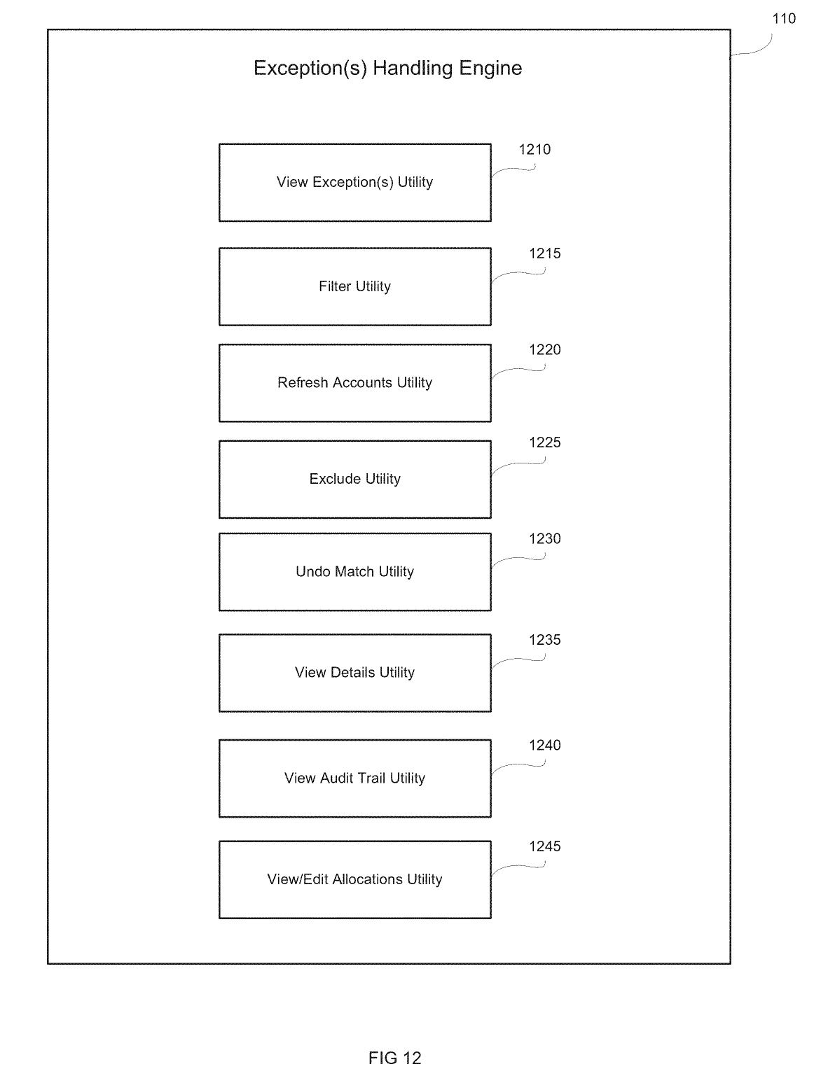

FIG. 12 is an exemplary embodiment illustrating various components of the Exception(s) Handling Engine 110. The Exception(s) Handling Engine 110 may include any combination of the following modules and in some embodiments may include a greater or lesser number of modules. The Exception(s) Handling Engine 110 may include View Exception(s) Utility 1210 that may display transaction failures, rejections, and any other error reason. The View Exception(s) Utility 1210 may allow a user to update any matched transactions that have a missing account number for one or more allocations. The View Exception(s) Utility 1210 may also display the current status of the No-Click IAP Application 70 and allow a user to correct downstream processing errors.

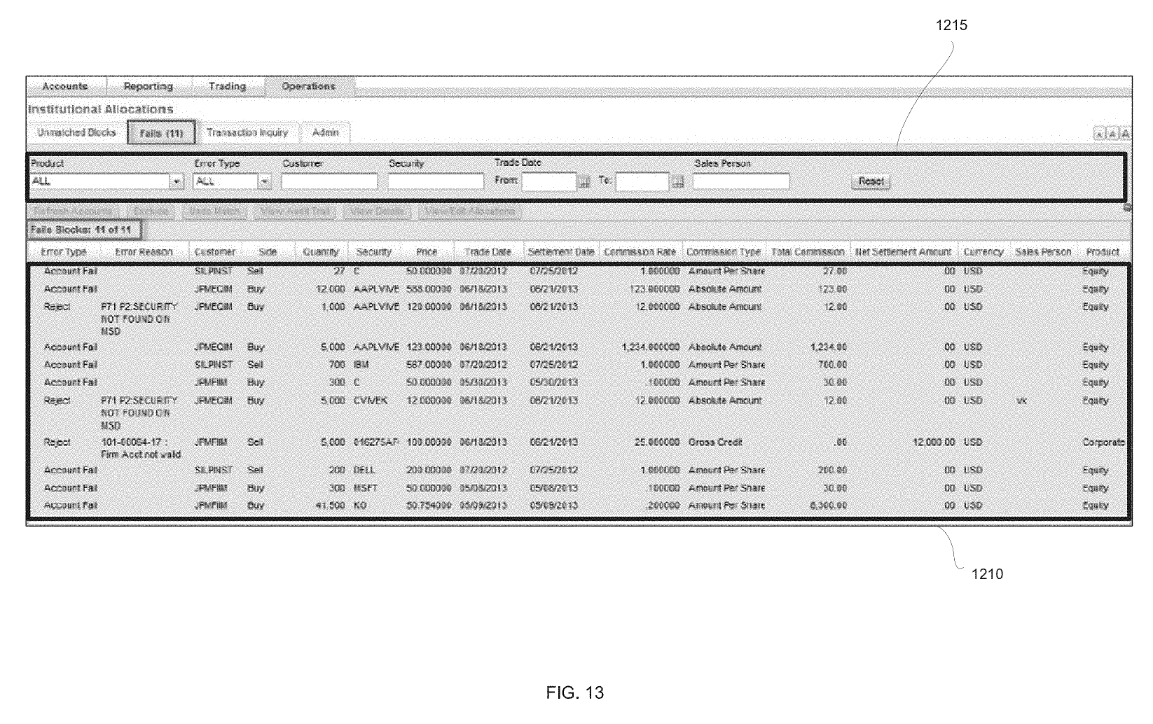

An example of a user interface of the View Exception(s) Utility 1210 is shown in FIG. 13. The user interface may display details for the exceptions, including, but not limited to, the error type, error reason, customer, side, quantity, security, price, trade date, settlement date, commission rate, commission type, total commission, net settlement amount, currency, sales person, and product.

The Exception(s) Handling Engine 110 may also include a Filter Utility 1215 that allows a user to filter the transaction failures, rejections, and any other error reason. Examples of filter criteria include, but are not limited to customer id, customer name, security, trade date, sales person, side, etc. The available values of a filter criterion may be dynamically populated based on one or more of the other filter criteria values. A user may also be able to type in a value in a filter criteria field. A type-ahead functionality may be available that may populate potential matches. An example of a user interface of the filter criteria is shown in FIG. 13.

The Exception(s) Handling Engine 110 may also include a Refresh Accounts Utility 1220 that verifies if the account(s) that need to be set up for one or more transaction(s) selected by the user using the View Exception(s) Utility 1210 have been created. Multiple accounts may be selected and refreshed at a time.

The Exception(s) Handling Engine 110 may also include an Exclude Utility 1225 that provides the ability to exclude one or more transaction(s) selected by the user using the View Exception(s) Utility 1210. The selected transactions may then be removed from list of the view of the View Exception(s) Utility 1210. A user may also have the ability to specify a reason for the exclusion.

The Exception(s) Handling Engine 110 may also include an Undo Match Utility 1230 that reverses transaction matching. A user may be able to select and un-match one or more transaction. The Exception(s) Handling Engine 110 may further include a View Details Utility 1235 that provides a user to view transaction details such as, but not limited to, symbol, customer, side, price, and quantity.

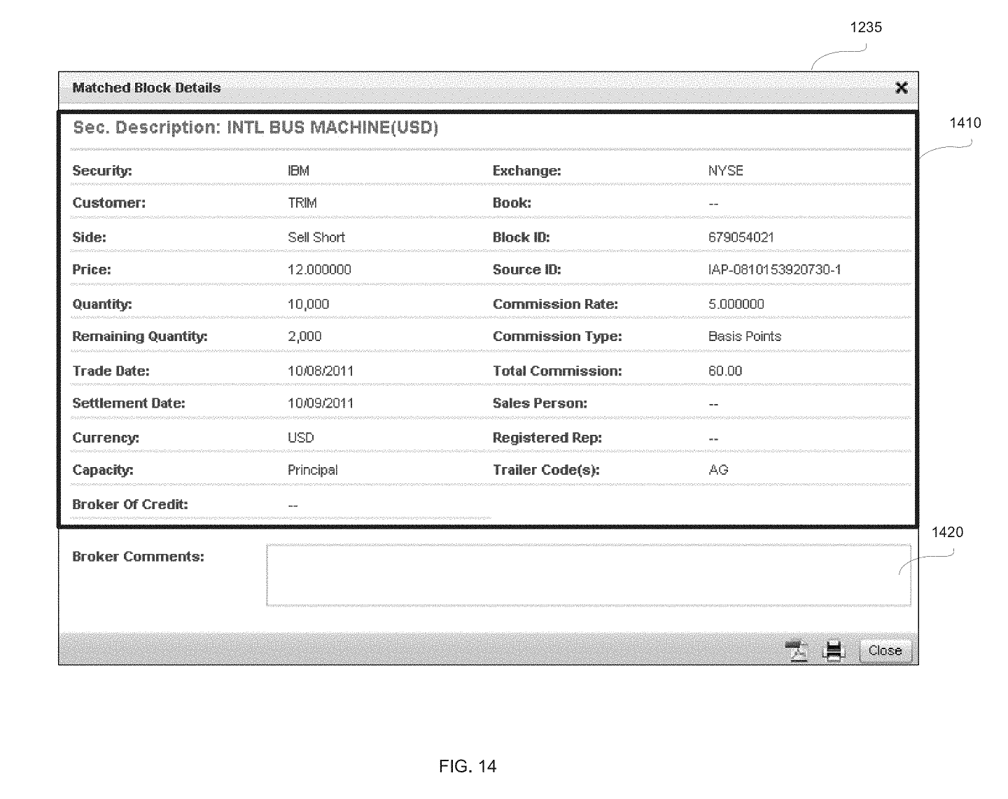

An example of a user interface of the View Details Utility 1235 is shown in FIG. 14. The user interface displays one or more parameters associated with a transaction 1410, such as, security, customer, side, price, quantity, remaining quantity, trade date, settlement date, currency, capacity, broker of credit, exchange, book, transaction id, source id, commission rate, commission type, total commission, sales person, registered representative, and trailer code. The user may also add comments 1420 to a transaction.

The Exception(s) Handling Engine 110 may also include a View Audit Trail Utility 1240 that allows users to view any updates or actions performed for a transaction.

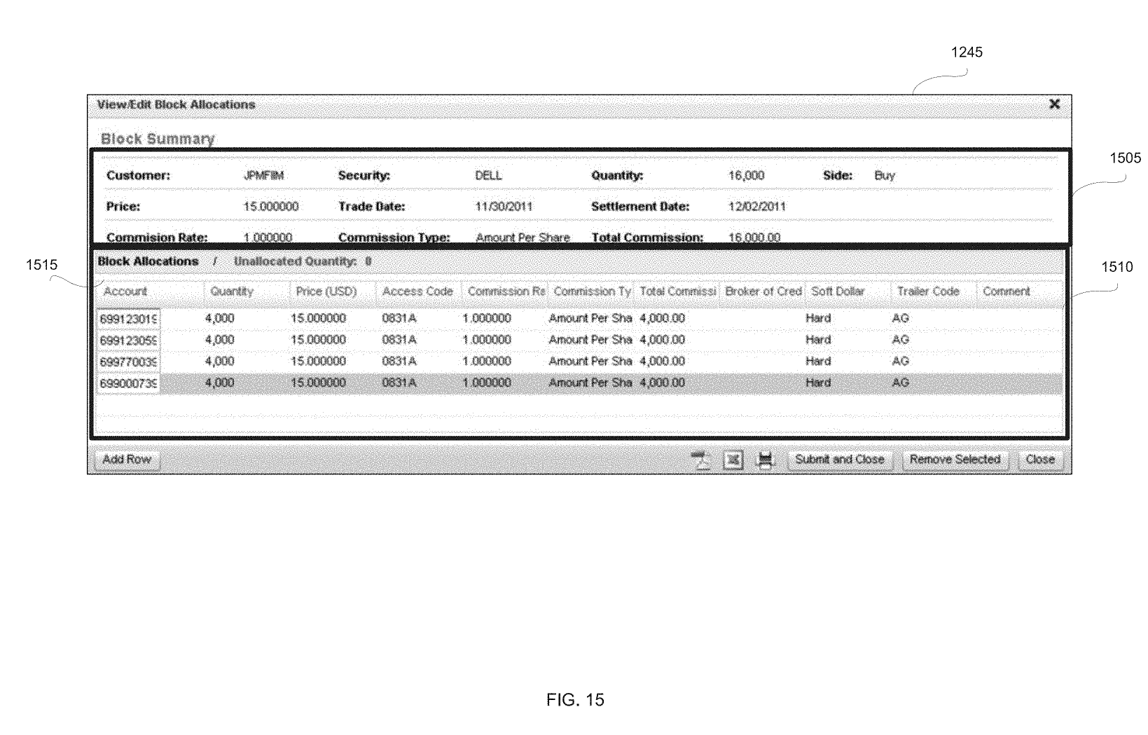

The Exception(s) Handling Engine 110 may further include a View/Edit Allocations Utility 1245 that allows users to view and manually enter or select account(s) that were created manually. A user may also be able to allocate a transaction either fully or partially. An example of a user interface of the View/Edit Allocations Utility 1245 is shown in FIG. 15. The user interface may have a section 1505 that displays details about a transaction, including but not limited to, customer, security, quantity, side, price, trade date, settlement date, commission rate, commission type, and total commission. The user interface may have another section 1510 that displays one or more allocation accounts associated with a transaction, including details about the allocations, such as, the allocation account number, quantity allocated, price, access code, commission rate, commission type, total commission, broker name, trailer code, accrued interest, and comments. The user interface may also display in 1515 the total allocated/unallocated quantity for a transaction.

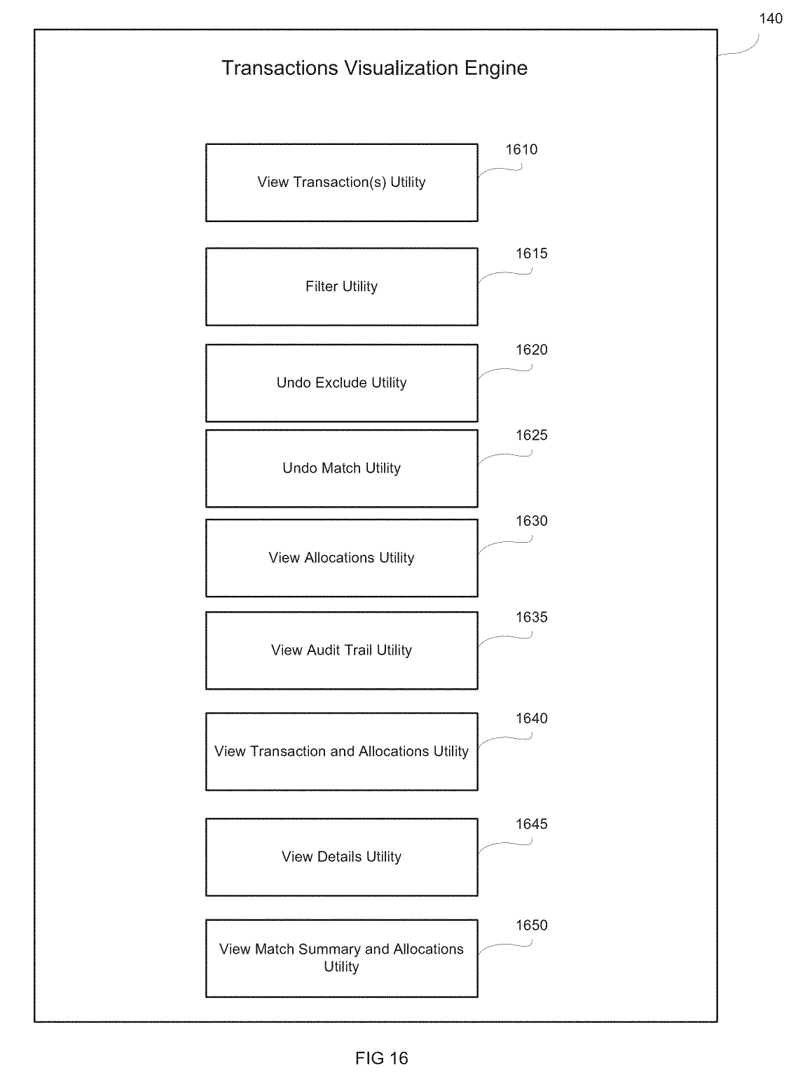

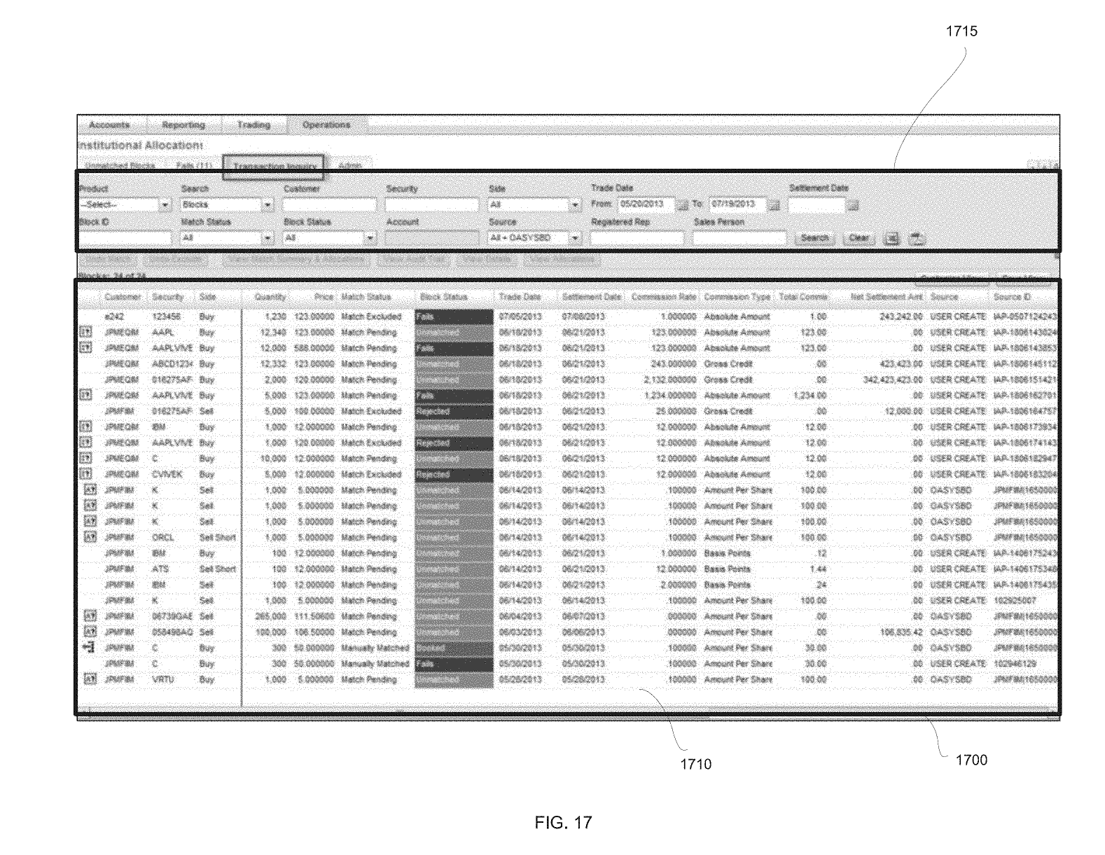

FIG. 16 is an exemplary embodiment illustrating various components of the Transaction(s) Visualization Engine 140 that provides the ability to search for transactions or allocations while making it easier to respond to inquiries. The transactions or allocations displayed may be matched or unmatched. The Transaction(s) Visualization Engine 140 may include any combination of the following modules and in some embodiments may include a greater or lesser number of modules. The Transaction(s) Visualization Engine 140 may include View Transaction(s) Utility 1610 that may display one or more transactions. An example of a user interface 1700 of the View Transaction(s) Utility 1610 is shown in FIG. 17. The user interface may display one or more attributes 1710 associated with a transaction, including, but not limited to, customer, security, side, quantity, price, match status, current status of the transaction (such as, Matched, Booked, Unmatched, Fails, etc.), trade date, settlement date, commission rate, commission type, total commission, net settlement amount, source, and source id.

The Transaction(s) Visualization Engine 140 may also include a Filter Utility 1615 that allows a user to filter transactions and/or allocations. Examples of filter criteria include, but are not limited to product, customer id, customer name, security, side, trade date, settlement date, transaction id, allocation id sales person, match status, account number, source, registered representative, etc. The available values of a filter criterion may be dynamically populated based on one or more of the other filter criteria values. A user may also be able to type in a value in a filter criteria field. A type-ahead functionality may be available that may populate potential matches. An example of a user interface 1715 of the Filter Utility 1615 is shown in FIG. 17.

The Transaction(s) Visualization Engine 140 may also include an Undo Exclude Utility 1620 that allows a user to un-do an exclusion for one or more selected transactions. The Transaction(s) Visualization Engine 140 may further include an Undo Match Utility 1625 that allows a user to un-match one or more matched transactions. A user may be able to select and un-match one or more transaction.

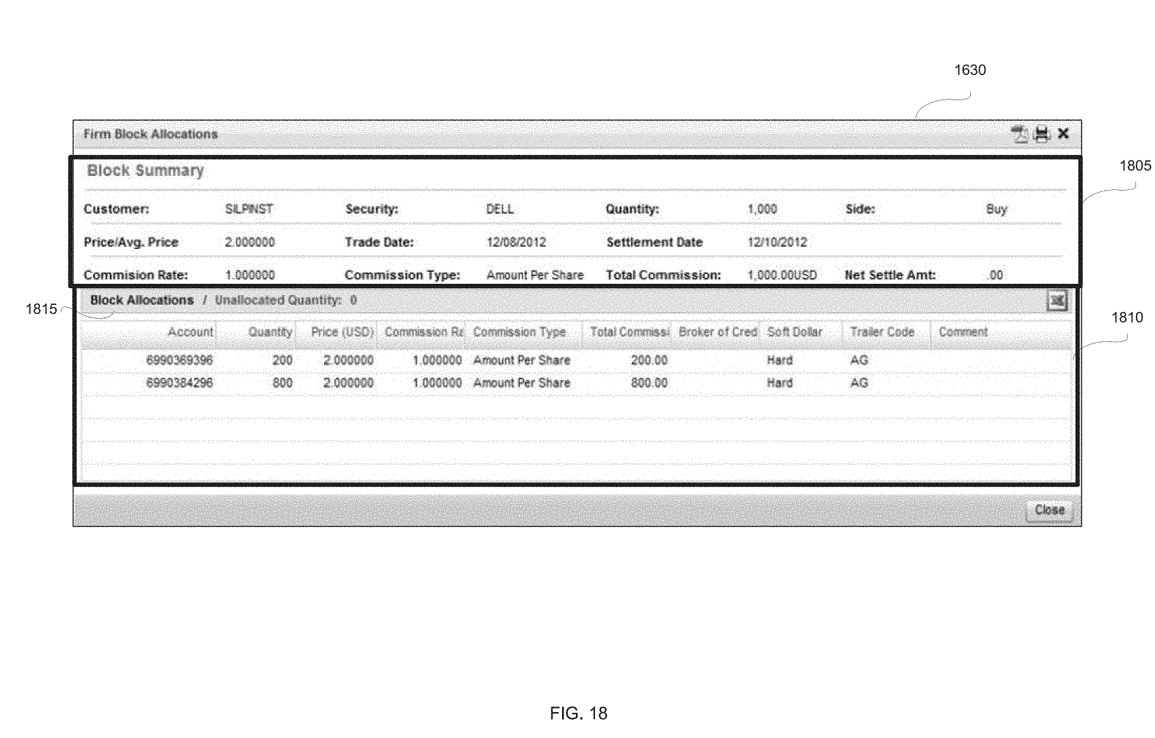

The Transaction(s) Visualization Engine 140 may further include a View Allocations Utility 1630 that allows a user to view allocations for a matched transaction with one or more allocation accounts. An example of a user interface of the View Allocations Utility 1630 is shown in FIG. 18. The user interface may have a section 1805 that displays details about a transaction, including but not limited to, customer, security, quantity, side, price, trade date, settlement date, commission rate, commission type, and total commission. The user interface may have another section 1810 that displays one or more allocation accounts associated with a transaction, including details about the allocations, such as, the allocation account number, quantity allocated, price, access code, commission rate, commission type, total commission, broker name, trailer code, accrued interest, and comments. The user interface may also display in 1815 the total allocated/unallocated quantity for a transaction.

The Transaction(s) Visualization Engine 140 may also include a View Audit Trail Utility 1635 that allows users to view any updates or actions performed for a transaction. The Transaction(s) Visualization Engine 140 may further include a View Transaction and Allocations Utility 1640 that allows users to view an allocation and its associated transactions. The allocation may be from a matched or unmatched transaction. The Transaction(s) Visualization Engine 140 may also include a View Details Utility 1645 that allows a user to view detailed information for one or more transactions and/or allocations, including, but not limited to, transaction id, security, customer, side, quantity, remaining quantity, exchange, book, sales person, registered representatives, trailer codes, coupon rate, accrued interest, net settlement amount, currency, price, trade date, settlement date, capacity, source id, commission rate, commission type, total commission, and comments.

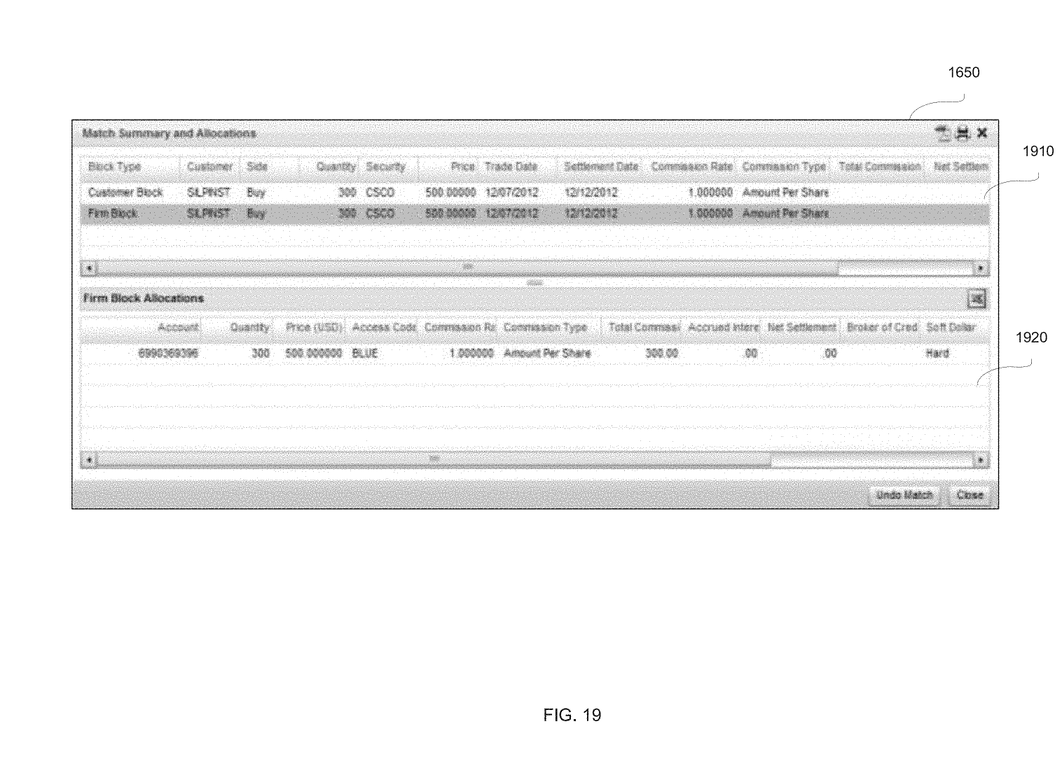

The Transaction(s) Visualization Engine 140 may further include a View Match Summary and Allocations Utility 1650 that allows users to view the details of a selected matched transaction and allocations. An example of a user interface of the View Match Summary and Allocations Utility 1650 is shown in FIG. 19. The View Match Summary and Allocations Utility 1650 may display details for each of the matched transaction 1910, including, but not limited to, the transaction type, customer, side, quantity, security, price, trade date, settlement date, commission rate, commission type, total commission, and net settlement amount. The View Match Summary and Allocations Utility 1650 may further display details of one or more allocation accounts associated with the matched transaction 1920, including, but not limited to, the allocation account number, quantity, price, access code, commission rate, commission type, total commission, accrued interest net settlement amount, and broker.

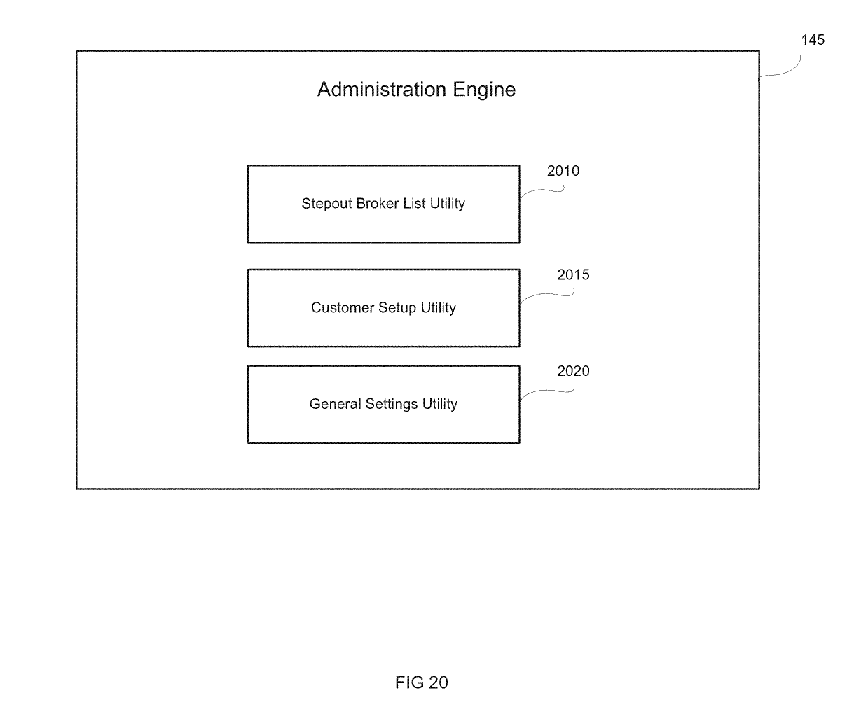

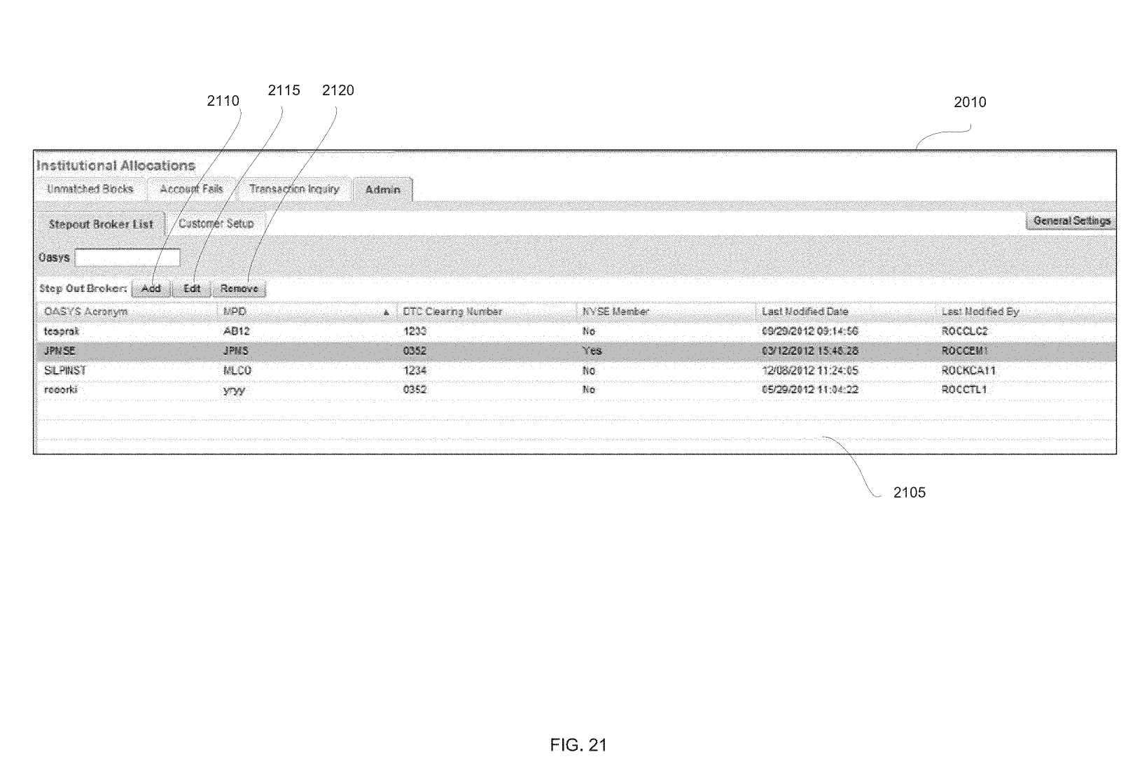

FIG. 20 is an exemplary embodiment illustrating various components of the Administration Engine 145 that allows a user to update one or more parameters of the No-Click IAP System 60. The Administration Engine 145 may include any combination of the following modules and in some embodiments may include a greater or lesser number of modules. The Administration Engine 145 may include a Stepout Broker List Utility 2010 that allows users to maintain a list of brokers for stepping out one or more allocations. An example of a user interface of the Step-out Broker List Utility 2010 is shown in FIG. 21. A user may be able to view details 2105 of the step-out brokers that currently exist in the application, including, but not limited to, the acronym for the broker, clearing number, membership, last modified date, and last modifying user. A user may be able to use add functionality 2110 to add a Step-out Broker to the existing list of Step-out brokers. A user may also be able to use edit functionality 2115 to edit the information of a current Step-out Broker. A user may also be able to use delete functionality 2120 to delete a Step-out Broker.

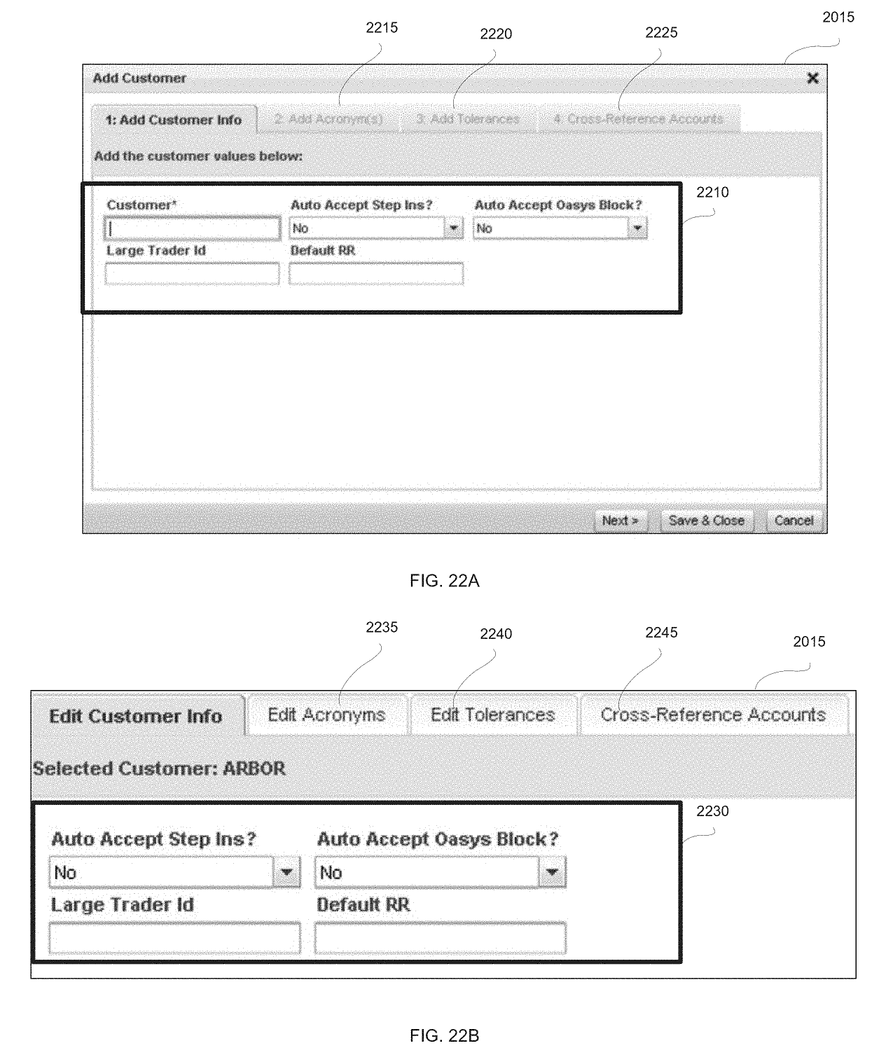

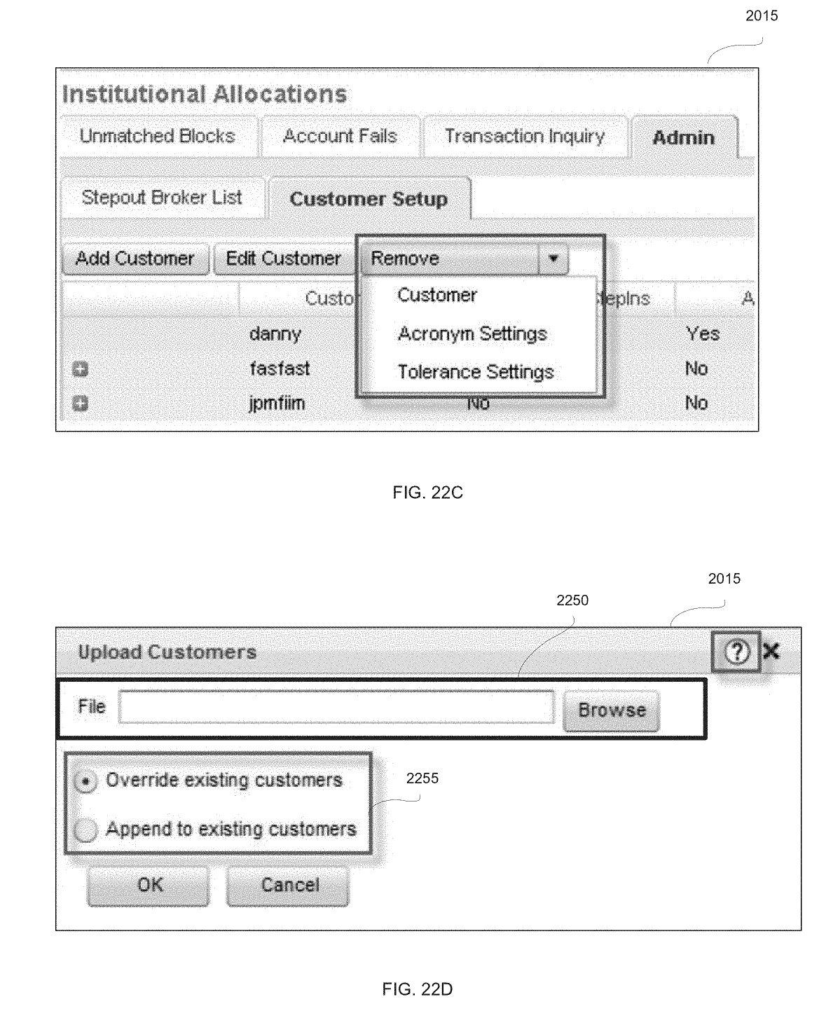

The Administration Engine 145 may further include a Customer Setup Utility 2015 that may provide the ability to create and maintain a list of customers. An example of a user interface of the add customer function of the Customer Setup Utility 2015 is shown in FIG. 22A. A user may be able to add a new customer including various parameters 2210 associated with the customer. Examples of parameters associated with a customer include, but are not limited to, customer information 2210 such as, customer identifier, which may be a name, number, or code, auto accept step ins, trader id, default registered representative, acronym information 2215, tolerance information 2220 for one or more transaction attributes, such as, tolerances, tolerance type, fixed/income products, rate/amount, and pre-emption, and cross-reference account information 2225, such as, access code, and account.

A user may also be able to edit customer information using the Customer Setup Utility 2015. An example of a user interface of the edit customer function of the Customer Setup Utility 2015 is shown in FIG. 22B. A user may be able to edit various parameters 2230 associated with a customer such as, auto account step-ins, auto acceptance of transactions, large trader id, and default registered representative. A user may also be able to edit one or more acronyms 2235 associated with a customer, one or more tolerance values 2240, and cross-reference account information 2245.

A user may further be able to remove a customer, an acronym setting, and/or a tolerance setting using the Customer Setup Utility 2015. An example of a user interface of the remove function of the Customer Setup Utility 2015 is shown in FIG. 22C. A user may also be able to import customers from an external system, such as a spreadsheet. The imported customers may override existing customers. In an embodiment of the invention, the imported customers may be appended to existing customers. An example of a user interface of the import customers function of the Customer Setup Utility 2015 is shown in FIG. 22D. A user may be able to select a file to be imported using 2250. A user may have the option 2255 to either override the existing customers with the imported file or append the imported customers to the existing customers list.

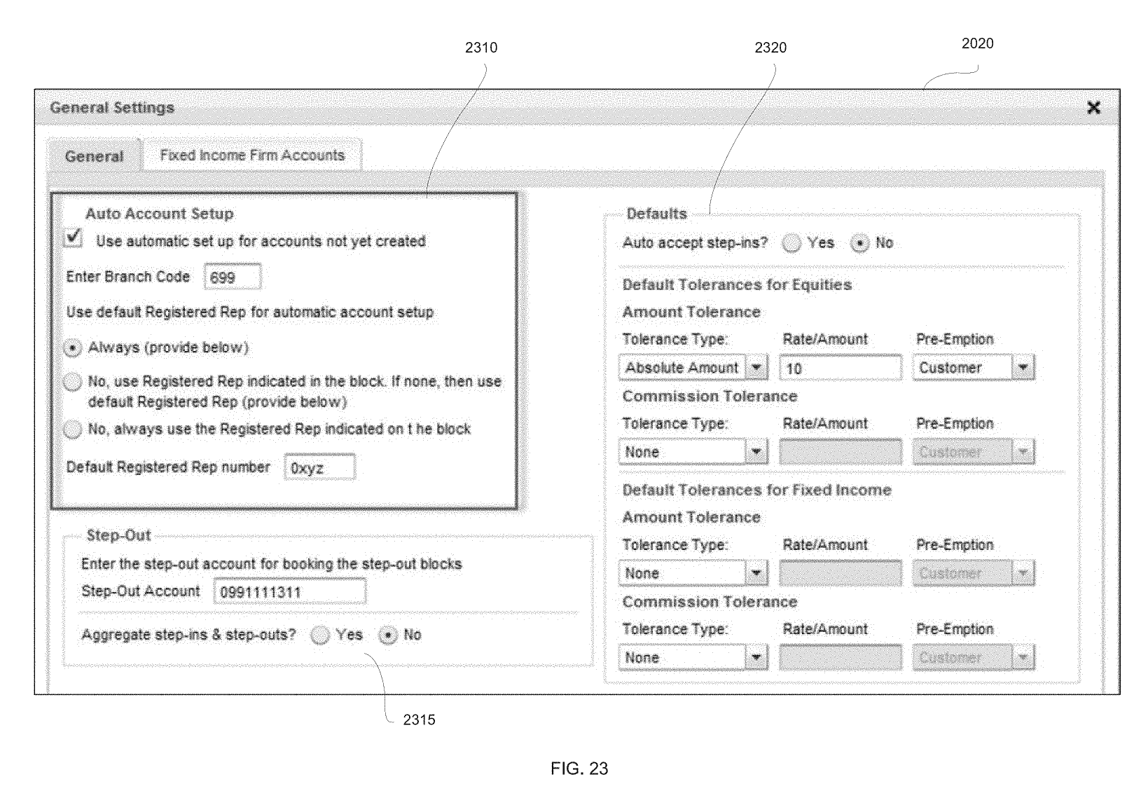

A user may also be able to edit general settings of the No-Click IAP System 60 using the General Settings Utility 2020. Examples of general settings include, but are not limited to, account setup settings, step out account number(s), default tolerances, etc. An example of a user interface of the General Settings Utility 2020 is shown in FIG. 23. A user may be able to edit auto account setup setting 2310, including, but not limited to, whether an automatic account should be setup for accounts not yet created, the branch code for the automatically created account, and default registered representative. A user may further edit the step-out settings 2315, such as, a step-out account number, and whether step-ins and step-outs may be aggregated. A user may further edit various default settings 2320, including, but not limited to, auto accept step-ins, default tolerance for equities (amount tolerance and commission tolerance), and default tolerance for fixed income securities (amount tolerance and commission tolerance).

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A computer-implemented method for automating the process of matching and settling at least two transactions utilizing an institutional allocation platform computing system, at least one transaction being performed as a step-out transaction across multiple broker-dealers, the method obtaining the at least two transactions from at least one external system over a network, the method comprising:
storing instructions in at least one non-transitory computer memory, the instructions including a transaction import engine, a transaction matching engine, a stepout processing engine, and a transaction visualization engine; and
implementing a computer processor for accessing the stored instructions in the non-transitory computer memory and executing the instructions to perform steps including:
importing data over a network from a customer-side allocations computing system and a broker dealer firm-side transaction computing system for the at least two transactions using the transaction import engine and storing the data in a database, the data including at least one customer side allocation and at least one broker-dealer firm-side transaction,
automatically matching at least a portion of each of the two transactions including a step-out transaction using the transaction matching engine by comparing at least one customer-side allocation to at least one broker-dealer firm side transaction and finding a match when matching criteria are within pre-set tolerance levels, thereby providing straight-through-processing in real time,
storing any imported unmatched transactions not meeting the pre-set tolerance levels in the database for future potential matches,
automatically completing the matched transactions using the step-out processing engine providing for at least one of said matched transactions including the step-out transaction to be settled and allocated across multiple broker-dealers,
sending a notification of the matched and completed transactions over a network to at least one user,
utilizing the transaction matching engine for presenting an unmatched user interface allowing the user to view the unmatched transactions,
identifying potential matches for the unmatched transactions from the database using the matching criteria,
allowing manual input to match the unmatched transactions with the potential matches or user-selected matches, and
presenting a user interface to display details of the completed transaction including the step-out transaction to the user using the transaction visualization engine, wherein the details of the completed transaction include display of multiple allocation accounts for the completed step-out transaction.

2. The computer-implemented method of claim 1, further comprising handling exceptions using an exception handling engine.

3. (canceled)

4. The computer-implemented method of claim 1, further comprising filtering transactions using the transaction matching engine.

5. (canceled)

6. The computer-implemented method of claim 1, further comprising adding at least one allocation for a transaction using the transaction matching engine.

7. The computer-implemented method of claim 1, further comprising displaying at least one allocation for a transaction using the transaction matching engine.

8. The computer-implemented method of claim 1, further comprising displaying details for at least one transaction using the transaction matching engine.

9. The computer-implemented method of claim 1, further comprising importing at least one allocation using the transaction matching engine.

10. The computer-implemented method of claim 1, wherein the transaction matching engine further includes a manual matching and allocation utility using the transaction matching engine.

11. The computer-implemented method of claim 10, further comprising allowing a user to modify parameters of at least one transaction using the manual matching and allocation utility.

12. The computer-implemented method of claim 10, further comprising creating at least one transaction using the manual matching and allocation utility.

13. The computer-implemented method of claim 10, further comprising merging at least two transactions using the manual matching and allocation utility.

14. The computer-implemented method of claim 10, further comprising resubmitting at least one transaction to the step-out processing engine using the manual matching and allocation utility.

15. The computer-implemented method of claim 2, further comprising displaying at least one exception using the exception handling engine.

16. The computer-implemented method of claim 2, further comprising filtering the exceptions using the exception handling engine.

17. A computer-based institutional allocation platform system for automating the process of matching and completing at least two transactions, at least one transaction being performed as a step-out transaction across multiple broker-dealers, comprising:
at least one non-transitory storage device storing data and instructions;
at least one computer processor accessing the data and instructions and executing instructions to perform steps including:
importing data over a network from a customer-side allocations computing system and a broker dealer firm-side transaction computing system for the at least two transactions, using a transaction import engine and storing the data in a database, the data including at least one customer side allocation and at least one broker-dealer firm-side transaction,
automatically matching at least a portion of each of the two transactions including a step-out transaction using the transaction matching engine by comparing at least one customer-side allocation to at least one broker-dealer firm side transaction and finding a match when matching criteria are within pre-set tolerance levels, thereby providing straight-through-processing in real time,
storing any imported unmatched transactions not meeting the pre-set tolerance levels in the database for future potential matches,
automatically completing the matched transactions using the step-out processing engine providing for at least one of said matched transactions including the step-out transaction to be settled and allocated across multiple broker-dealers,
sending a notification of the matched and completed transactions over a network to at least one user,
utilizing the transaction matching engine for presenting an unmatched user interface allowing the user to view the unmatched transactions,
identifying potential matches for the unmatched transactions from the database using the matching criteria,
allowing manual input to match the unmatched transactions with the potential matches or user-selected matches, and
presenting a user interface using a transaction visualization engine to display details of the completed transaction including the step-out transaction to the user, wherein the details of the completed transaction include display of multiple allocation accounts for the completed step-out transaction.

18. The computer-based system of claim 17, further comprising an exception handling engine.

19. (canceled)

20. The computer-based system of claim 17, wherein the transaction matching engine includes a filter utility.

21. (canceled)

22. The computer-based system of claim 17, wherein the transaction matching engine adds at least one allocation for a transaction.

23. The computer-based system of claim 17, wherein the transaction matching engine displays at least one allocation for at least one transaction.

24. The computer-based system of claim 17, wherein the transaction matching engine displays details for at least one transaction.

25. The computer-based system of claim 17, wherein the transaction matching engine imports at least one allocation.

26. The computer-based system of claim 17, wherein the transaction matching engine further includes a manual matching and allocation utility.

27. The computer-based system of claim 26, wherein the manual matching and allocation utility allows a user to modify parameters of at least one transaction.

28. The computer-based system of claim 26, wherein the manual matching and allocation utility creates at least one transaction.

29. The computer-based system of claim 26, wherein the manual matching and allocation utility merges at least two transactions.

30. The computer-based system of claim 26, wherein the manual matching and allocation utility resubmits at least one transaction to the step-out processing engine.

31. The computer-based system of claim 18, wherein the exception handling engine displays at least one exception.

32. The computer-based system of claim 18, wherein the exception handling engine includes a filter utility.

33. A computer-implemented method for automating the process of matching and completing at least two transactions utilizing an institutional allocation platform computing system, at least one transaction being performed as a step-out transaction across multiple broker-dealers, the method obtaining the at least two transactions from at least one external system over a network, the method comprising:
storing instructions on at least one non-transitory computer memory, the instructions including a transaction import engine, a transaction matching engine, a step-out processing engine, an exception handling engine, and a transaction visualization engine; and
implementing a computer processor for accessing the stored instructions in the nontransitory computer memory and executing the instructions to perform steps including:
importing data over a network from a customer-side allocations computing system and a broker dealer firm-side transaction computing system for the at least two transactions using the transaction import engine and storing the data in a database, the data including at least one customer side allocation and at least one broker-dealer firm-side transaction,
automatically matching at least a portion of each of the two transactions including a step-out transaction using the transaction matching engine by comparing at least one customer-side allocation to at least one broker-dealer firm side transaction and finding a match when matching criteria are within pre-set tolerance levels, thereby providing straight-through-processing in real time,
handling at least one exception by the exception handling engine,
storing any imported unmatched transactions not meeting the pre-set tolerance levels in the database for future potential matches,
if the at least one exception is successfully handled or there is no exception,
automatically completing the matched transactions using the step-out processing engine providing for at least one of said matched transactions including the step-out transaction to be settled and allocated across multiple broker-dealers,
sending a notification of the matched and completed transactions over a network to at least one user,
utilizing the transaction matching engine for presenting an unmatched user interface allowing the user to view the unmatched transactions,
identifying potential matches for the unmatched transactions from the database using the matching criteria,
allowing manual input to match the unmatched transactions with the potential matches or user-selected matches, and
presenting a user interface to display details of the completed transaction including the step-out transaction to the user using the transaction visualization engine, wherein the details of the completed transaction include display of multiple allocation accounts for the completed step-out transaction.

34. A computer-implemented institutional allocation platform system for automating the process of matching and completing at least two transactions, at least one transaction being performed as a step-out transaction across multiple broker-dealers, the method obtaining the at least two transactions from at least one external system over a network, the system comprising:
instructions stored in at least one non-transitory computer memory, the instructions including a transaction import engine, a transaction matching engine, a step-out processing engine, an exception handling engine, and a transaction visualization engine; and
a computer processor for accessing the stored instructions in the non-transitory computer memory and executing the instructions to perform steps including:
importing data over a network from a customer-side allocations computing system and a broker-dealer firm-side transaction computing system for the at least two transactions using the transaction import engine and storing the data in a database, the data including at least one customer side allocation and at least one broker-dealer firm-side transaction,
automatically matching at least a portion of each of the two transactions including a step-out transaction using the transaction matching engine by comparing at least one customer-side allocation to at least one broker-dealer firm side transaction and finding a match when matching criteria are within pre-set tolerance levels, thereby providing straight-through-processing in real time,
handling at least one exception by the exception handling engine,
storing any imported unmatched transactions not meeting the pre-set tolerance levels in the database for future potential matches,
if the at least one exception is successfully handled or there is no exception,
automatically completing the matched transactions using the step-out processing engine providing for at least one of said matched transactions including the step-out transaction to be settled and allocated across multiple broker-dealers,
sending a notification of the matched and completed transactions over a network to at least one user,
utilizing the transaction matching engine for presenting an unmatched user interface allowing the user to view the unmatched transactions,
identifying potential matches for the unmatched transactions from the database using the matching criteria,
allowing manual input to match the unmatched transactions with the potential matches or user-selected matches, and
presenting a user interface using a transaction visualization engine to display details of the completed transaction including the step-out transaction to the user, wherein the details of the completed transaction include display of multiple allocation accounts for the completed step-out transaction.

35-38. (canceled)
